(19) United States
(12) Patent Application Publication
(10) Pub. No.: US 2011/0167045 A1
(43) Pub. Date: Jul. 7, 2011

(54) STORAGE SYSTEM AND ITS FILE MANAGEMENT METHOD

(75) Inventor: Takuya Okamoto, Machida (JP)

(73) Assignee: HITACHI, LTD., Chiyoda-ku, Tokyo (JP)

(21) Appl. No.: 12/669,166

(22) PCT Filed: Jan. 5, 2010
(86) PCT No.: PCT/JP2010/000030

§ 371 Date: Jan. 14, 2010

(51) Int. Cl. G06F 17/30; G06F 15/167

(52) U.S. Cl. 707/661; 709/214; 707/E17.005; 707/E17.01

(57) ABSTRACT

A storage system capable of providing a referral target file to a file referral requestor client even if a file referral request is made before migration. When a file server 12 registers a file 26 in a storage apparatus 14, it sends metadata 28 added to the file 26 to an archive server 16, and the archive server 16 creates a stub 30 based on the received metadata 28, and registers the metadata 28 and the stub 30 in the storage apparatus 18. If the archive server 16 receives a file referral request before migration and determines that the storage destination of the file 26 is the storage apparatus 14 based on the stub 30, it requests the file server 12 to execute the migration, receives the file 26 in the storage apparatus 14 from the file server 12, and provides the file 26 to a referring client 22.

### TECHNICAL FIELD

The present invention relates to a storage system and its file management method for managing files stored in a memory device together with their metadata, and, when a file becomes a migration target file, migrating the migration target file to another memory device, and managing the migrated file as a referral target file at the migration destination.

### BACKGROUND ART

As a storage system, known is a type where a first storage subsystem comprising a first storage apparatus and a file server is connected with a second storage subsystem comprising a second storage apparatus and an archive server via a network. With this kind of storage system, data concerning various files is stored in the first storage apparatus and, for instance, a file with low access frequency is selected as the migration target file among the files, and the selected migration target file is sent from the file server to the archive server at an optimal timing; for instance, at night or the like when the load of the network connecting the storage subsystems is low.

Here, proposed is a type where the features of NAS (Network Attached Storage) or CAS (Content Aware Storage) are applied to the files stored in the first storage apparatus so as to migrate files without transferring the files (refer to PTL 1).

### CITATION LIST

### Patent Literature

PTL 1: Japanese Unexamined Patent Application Publication No. 2009-87320

### SUMMARY OF INVENTION

### Technical Problem

Meanwhile, after the file server registers a file in the first storage apparatus, there are cases where a referring client inputs a file referral request to the archive server designating the migration target file as the referral target file before the processing for migrating the migration target file between the file server and the archive server is executed.

In the foregoing case, the archive server is unable to provide the referral target file designated in the file referral request to the referring client since the second storage apparatus is not storing the referral target file that was designated in the file referral request.

Specifically, with a conventional storage system, if the second storage apparatus under the control of the archive server does not have the file (file entity), even if a file referral request is input from the referring client to the archive server, the archive server is unable to provide the referral target file that was designated in the file referral request to the referring client.

The present invention was devised in view of the foregoing problems encountered in conventional technology. Thus, an object of this invention is to provide a storage system and its file management method capable of providing a referral target file, which is the target of the file referral request, to the file referral requestor client even if the file referral requestor client inputs a file referral request to the migration designation before the file of the migration source is migrated to the migration destination.

### Solution to the Problem

In order to achieve the foregoing object, the present invention provides a storage system having the following characteristics. Specifically, when the first server receives a file registration request from a file registration requestor, the first server stores a file that was input pursuant to the file registration request and metadata added to the file in the first memory device, sends the metadata to the second server, and, when the file that was input together with the file registration request subsequently becomes a migration target, sends a migration target file that became the migration target to the second server. In addition, when the second server receives the metadata that was sent from the first server, the second server creates a stub as referral information for accessing a file corresponding to the received metadata based on the received metadata, stores the created stub and the received metadata in the second memory device, and, upon subsequently receiving a file referral request from a file referral requestor client, searches for the stub and the metadata stored in the second memory device according to the file referral request, determines a storage destination of a referral target file as a target of the file referral request based on the search result, and provides the referral target file existing in the determined storage destination to the file referral requestor client.

### Advantageous Effects of Invention

According to the present invention, it is possible to provide a referral target file, which is the target of the file referral request, to the file referral requestor client even if the file referral requestor client inputs a file referral request to the migration designation before the file of the migration source is migrated to the migration destination.

### BRIEF DESCRIPTION OF DRAWINGS

FIG. 1 A conceptual diagram explaining the concept of the present invention.

FIG. 2 A configuration diagram of the storage system showing Example 1 of the present invention.

FIG. 3 A module diagram of a program that runs with a program memory of a file server.

FIG. 4 A module diagram of a program that runs with a program memory of an archive server.

FIG. 5 A conceptual diagram explaining the file/metadata storage node control processing in the archive server.

FIG. 6A A configuration diagram of retained information of a post-migration stub in the archive server.

FIG. 6B A configuration diagram of retained information of a pre-migration stub in the archive server.

FIG. 7 A configuration diagram of a hash map.

FIG. 8 A flowchart explaining the metadata storage destination node determination processing in the archive server.

FIG. 9 A diagram showing a display example of a file registration screen.

FIG. 10 A conceptual diagram explaining the processing during file registration/update.

FIG. 11 A flowchart explaining the file registration/update processing in the file server.

FIG. 12 A configuration diagram of a metadata management table in the file server.

FIG. 13 A flowchart explaining the stub creation and metadata registration/update processing in the archive server.

FIG. 14A A configuration diagram of a metadata management table in the archive server.

FIG. 14B A configuration diagram of extended metadata.

FIG. 15 A conceptual diagram explaining the processing during migration execution.

FIG. 16 A configuration diagram of a migration policy.

FIG. 17 A configuration diagram of retaining information of a stub in the file server.

FIG. 18 A flowchart explaining the migration processing in the file server.

FIG. 19 A flowchart explaining the migration target file registration processing in the archive server.

FIG. 20 A conceptual diagram explaining the processing during file referral in the file server.

FIG. 21 A diagram showing a display example of a file referral screen.

FIG. 22 A flowchart explaining the file referral processing in the file server.

FIG. 23 A flowchart explaining the file entity send processing in the archive server.

FIG. 24 A conceptual diagram explaining the processing during file referral in the archive server.

FIG. 25 A flowchart explaining the file referral processing in the archive server.

FIG. 26 A flowchart explaining the file entity send processing in the file server.

FIG. 27 A conceptual diagram explaining the operation upon adding a node to the archive server.

FIG. 28 A flowchart explaining the operation upon adding a node to the archive server.

FIG. 29 A configuration diagram of a hash map upon adding a node to the archive server.

FIG. 30 A flowchart explaining the file registration processing in Example 2 of the present invention.

FIG. 31 A conceptual diagram explaining the operation in Example 3 of the present invention.

FIG. 32 A configuration diagram of retained information of a stub of a file server in Example 3 of the present invention.

### DESCRIPTION OF THE EMBODIMENTS

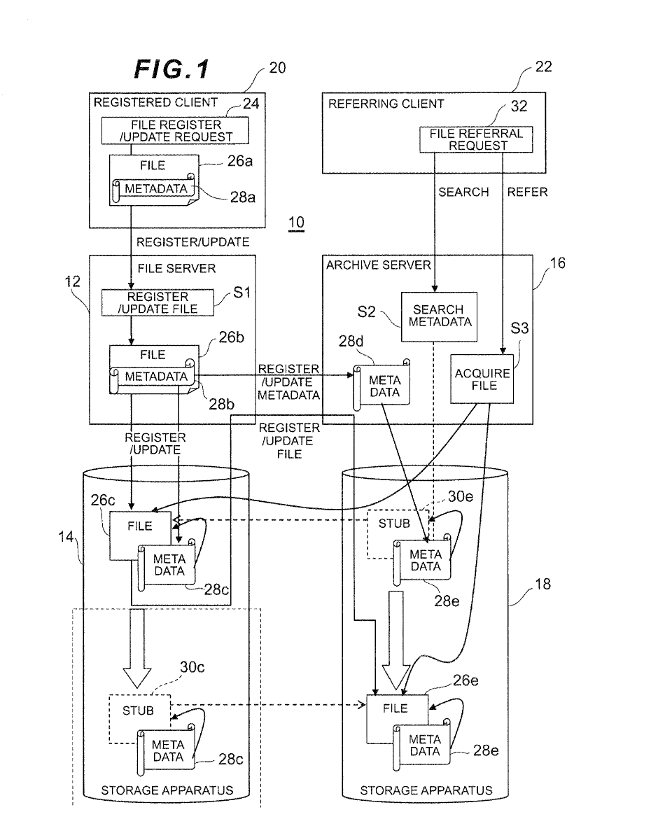

The concept of this invention is now explained with reference to FIG. 1.

In FIG. 1, a storage system 10 comprises a file server 12 and a first storage apparatus 14 as a first storage subsystem, and comprises an archive server 16 and a second storage apparatus 18 as a second storage subsystem. The file server 12 and the archive server 16 are mutually connected via a network (not shown), the file server 12 is connected to a registered client 20 via a network (not shown), and the archive server 16 is connected to a referring client 22 via a network (not shown).

The registered client 20 is configured as a file registration/update requestor client that creates a file registration/update request 24 according to an application program, and sends the file registration/update request 24 and a file 26a including metadata 28a to the file server 12.

Here, the term “file” is a collection of data having a certain association, and contains a file body or a file entity as the real data, and metadata. However, a file is sometimes simply referred to as a “file” without differentiating the file body or file entity and the metadata.

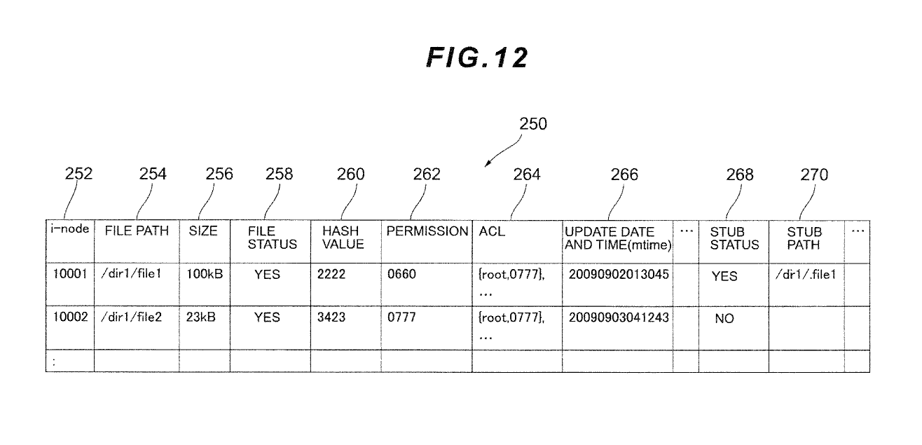

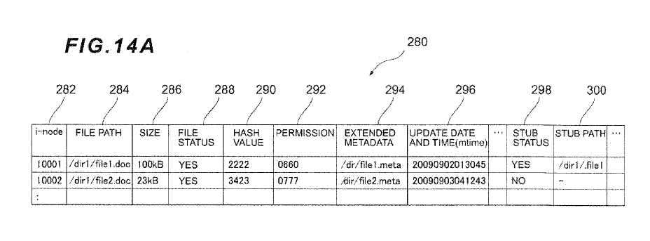

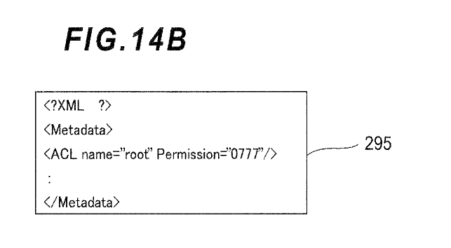

In addition, the term “metadata” is the attribute information of a file and, as described later, includes information related to the file path, file size, file status, hash value of the file, update date and time of the file, stub status and so on (refer to FIG. 12, FIG. 14A, FIG. 14B).

When the file server 12 receives the file registration/update request 24, it executes processing for registering and updating the file 26a and the metadata 28a which were input pursuant to the file registration/update request 24 (S1).

Subsequently, the file server 12 executes processing for registering the file 26b that was subject to the registration/update processing in the first storage apparatus 14 or executes update processing to the registered file 26c, and executes processing for registering the metadata 28b that was subject to the registration/update processing in the first storage apparatus 14 or executes processing for updating the registered metadata 28c. Moreover, the file server 12 extracts the metadata 28b that was added to the file 26b, and sends the extracted metadata 28b to the archive server 16.

When the archive server 16 receives the metadata 28d from the file server 12, it executes processing for registering the received metadata 28d in the second storage apparatus 18. Subsequently, the archive server 16 creates a stub 30e as referral information for accessing the file 26e based on the registered metadata 28e, and stores the created stub 30e in the second storage apparatus 18 upon associating it with the metadata 28e. Here, the stub 30e is referral information for accessing the file 26c that is stored in the first storage apparatus 14 as the migration source, and is referral information showing the storage destination of the file 26c that is stored in the first storage apparatus 14.

Subsequently, when the referring client 22 creates a file referral request 32 for searching for or referring to the file 26c stored in the first storage apparatus 14, the referring client 22 sends the file referral request 32 to the archive server 16.

The archive server 16 executes metadata search processing if a search is requested in the file referral request 32 (S2), and performs processing for searching for the metadata 28e and the stub 30e stored in the second storage apparatus 18.

Here, the archive server 16 searches for the metadata 28e and the stub 30e, acquires information from the metadata 28e stored in the second storage apparatus 18 to the effect that the file 26e does not exist in the second storage apparatus 18, acquires referral information from the stub 30e to the effect that the storage destination of the file 26e is the first storage apparatus 14, and sends the respectively acquired information as the search result to the referring client 22.

The referring client 22 creates a file referral request (file referral request in which the file 26c stored in the first storage apparatus 14 is the referral target file) 32 based on the search result, and sends the created file referral request 32 to the archive server 16.

When the archive server 16 receives the file referral request 32 and the referral of the file is requested in the file referral request 32, it executes file acquisition processing (S3). Here, if the stub 30e is storing information to the effect that the first storage apparatus 14 is the storage destination of the file 26, the archive server 16 sends a request to the file server 12 for acquiring the file 26c from the first storage apparatus 14.

Here, in response to the request from the archive server 16, the file server 12 executes migration processing for migrating the file 26c stored in the first storage apparatus 14 as the migration target file to the second storage apparatus 18.

When the file server 12 executes the migration processing, the file 26c registered in the first storage apparatus 14 is sent from the file server 12 to the archive server 16. Here, the archive server 16 registers the received file 26d in the second storage apparatus 18.

In the foregoing case, if the migration target file 26c is deleted from the first storage apparatus 14 pursuant to the migration processing, the file server 12 performs processing for reflecting information concerning such migration target file 26c in the stub 30c.

Specifically, the file server 12 creates a stub 30c to the effect that the storage destination of the migration target file 26c has been changed to the second storage apparatus 14 based on the metadata 28c that was added to the migration target file 26c. When copying the file 26c stored in the first storage apparatus 14 to the second storage apparatus 18, as shown with the broken line, the processing associated with the migration is not executed.

Meanwhile, if the migration target file 26c is stored as the file e in the second storage apparatus 18 as the storage destination pursuant to the migration processing, the archive server 16 executes processing for reflecting the information concerning the stub 30e stored in the second storage apparatus 18 in the file 26e and the metadata 28e.

For example, the archive server 12 executes processing for deleting the stub 30e or changing the information of the stub 30e. When changing the information of the stub 30e, the archive server 16 stores referral information to the effect that the storage destination of the file 26e is the second storage apparatus 18 in the stub 30e. The archive server 16 additionally changes the file status in the metadata 28e to the effect that the file 26e exists in the second storage apparatus 18, and changes information concerning the stub status in accordance with the status of the stub 30e.

The archive server 16 executes processing for reflecting the contents of the metadata 28e in the file 26e that is stored in the second storage apparatus 18.

Subsequently, the archive server 16 performs processing for acquiring the file 26e stored in the second storage apparatus 18, and executes processing for providing the acquired file 26e as the referral target file 26 to the referring client 22. The referring client 22 is thereby able to acquire the referral target file 26 that was designated in the file referral request 32.

Meanwhile, after the file 26c is registered in the first storage apparatus 14 and the metadata 28e and the stub 30e are registered in the second storage apparatus 18, if the referring client 22 inputs the file referral request 32 to the archive server 16 before the predetermined migration execution timing, migration is executed at the predetermined migration execution timing.

For example, among the files 26c registered in the first storage apparatus 14, a file 26c that satisfies the migration condition; for instance, the condition where the access frequency falls below the setting value is set as the migration target file to be migrated, and migration processing is executed for sending this migration target file 26c from the file server 12 as the migration source to the archive server 16 as the migration destination.

When the file server 12 executes the migration processing, the file 26c registered in the first storage apparatus 14 is sent from the file server 12 to the archive server 16. Here, the archive server 16 registers the received file 26d in the second storage apparatus 18 as the file 26e.

When the file referral request 32 is thereafter input from the referring client 22 to the archive server 16, the archive server 16 executes the metadata search processing (S2), searches for the metadata 28e and the stub 30e, acquires information from the metadata 28e stored in the second storage apparatus 18 to the effect that the file 26e exists in the second storage apparatus 18, and, in cases where there is a stub 30e, acquires referral information from the stub 30e showing that the storage destination of the file 26e is the second storage apparatus 18, and sends the respectively acquired information as the search result to the referring client 22.

The referring client 22 issues the file referral request 32 to the archive server 16 based on the search result. Here, since the file 26e exists in the second storage apparatus 18, upon executing the file acquisition processing (S3) in response to the file referral request 32, the archive server 16 directly acquires the file 26e from the second storage apparatus 18, and provides the acquired file 26e to the referring client 22. The series of processing flows are shown with the arrows.

As described above, when the file referral request 32 is input from the referring client 22 as the file referral requestor, even if the referral target file 26 of the referral target file 26 does not exist in the second storage apparatus 18, the archive server 16 is able to provide the referral target file 26 to the referring client 22 by requesting the file server 12 to perform migration processing.

Thus, according to the present invention, even if a file referral request is input from the referring client 22 as the file referral requestor to the archive server 16 as the migration destination before the file 26 of the migration source is migrated to the migration destination, the file 26 of the migration source can be provided as the referral target file 26 from the archive server 16 to the referring client 22.

Incidentally, instead of deleting the stub 30e stored in the second storage apparatus 18 after the migration is complete, the archive server 16 may perform change processing to the metadata 28e and the stub 30e for changing the storage destination of the file 26 to the second storage apparatus 18, and storing both the changed stub 30e and metadata 28e in the second storage apparatus 18.

### Example 1

In Example 1, when the file server is to register a file in the first storage apparatus, the metadata (attribute information of the file) added to the registration target file is sent from the file server to the archive server. The archive server creates a stub (referral information for accessing the file of the migration source) based on the received metadata, registers the received metadata and the created stub in the second storage apparatus, and, if a file referral request is made to the archive server before migrating the file registered in the first storage apparatus to the second storage apparatus, the archive server requests the file server to execute migration based on the stub, and provides the file registered in the first storage apparatus to the file referral requestor.

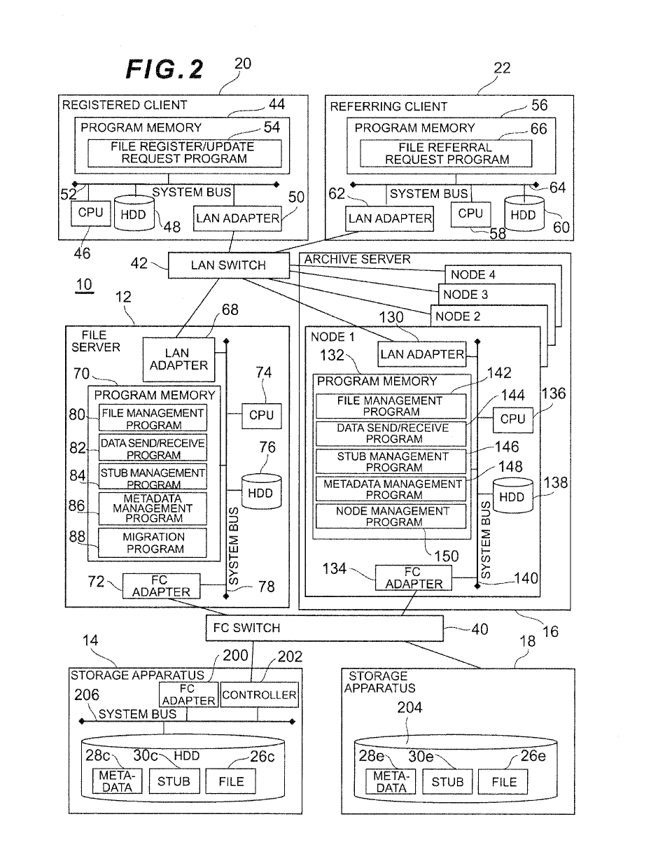

Example 1 of this invention is now explained with reference to the drawings. FIG. 2 is a configuration diagram of the storage system showing Example 1 of this invention.

In FIG. 2, the storage system 10 comprises a file server 12, a first storage subsystem including a first storage apparatus 14 for storing data concerning a plurality of files 26, an archive server 16, and a second storage subsystem including a second storage apparatus 18. The file server 12, the archive server 16, the first storage apparatus 14 and the second storage apparatus 18 are mutually connected via an FC (Fibre Channel) switch 40, and the file server 12 and the archive server 16 are connected to a registered client 20 and a referring client 22 via a LAN (Local Area Network) switch 42.

The registered client 20 is a computer having an I/O device and comprises a program memory 44, a CPU (Central Processing Unit) 46, an HDD (Hard Disk Drive) 48, and a LAN adapter 50, and the foregoing components are mutually connected via a system bus 52. The LAN adapter 50 is connected to a LAN switch 42 as an interface, and the program memory 44 stores a file registration/update request program 54.

As a result of the CPU 46 executing the file registration/update request program 54, the registered client 20 is able to issue a file registration request or a file update request to the file server 12 for registering or updating the file stored in the HDD 48. Specifically, the registered client 20 is configured as a host (host computer); more specifically as a file registration requestor client or a file update requestor client, for issuing a file registration request or a file update request to the file server 12.

The referring client 22 is a computer including an I/O device and comprises a program memory 56, a CPU 58, an HDD 60, and a LAN adapter 62, and the foregoing components are mutually connected via a system bus 64. The LAN adapter 62 is connected to the LAN switch 42 as an interface, and the program memory 56 stores the file referral request program 66.

As a result of the CPU 58 executing the file referral request program 66, the referring client 22 is configured as a host (host computer); more specifically, a file referral requestor client, for issuing a file referral request to the file server 12 or the archive server 16.

The file server 12 is a computer including an I/O device and comprises a LAN adapter 68, a program memory 70, an FC adapter 72, a CPU 7, and an HDD 76, and is configured as a first server or a first controller for controlling the input and output of data to and from the first memory device 14, and the foregoing components are mutually connected via a system bus 78. The LAN adapter 68 is connected to the LAN switch 42 as an interface, and the FC adapter 72 is connected to the FC switch 40 as an interface. The FC switch 40 is configured, for example, as a SAN (Storage Area Network).

The archive server 16 is configured from four computers including an I/O device as a second server or a second controller for controlling the input and output of data to and from the second memory device 18. Each computer sends and receives data to and from the file server 12 via the LAN switch 42, and includes the function of sending and receiving data to and from the second storage apparatus 18 via the FC switch 40 with the second storage apparatus 18 as the access target.

Here, in this Example, these computers are defined as a node 1, a node 2, a node 3, and a node 4 for the sake of convenience. The nodes 1 to 4 are configured the same and comprise a LAN adapter 130, a program memory 132, an FC adapter 134, a CPU 136, and an HDD 138, and the foregoing components are mutually connected via a system bus 140.

The nodes 1 to 4 in the file server 12 have the function of an SNS (Single Name Space), and the plurality of nodes 1 to 4 operate as a single node. Thus, the metadata 28 of each of the nodes 1 to 4 stores, as described later, information for specifying the node in which the file 26 is stored and specifying the file 26 in that node. As a result of using this information as the retained information of the stub 30 for the identifier to be used in identifying the file 26c in the pre-migration first memory device 14, access from the archive server 16 to the file server 12 is enabled.

The LAN adapter 130 is connected to the LAN switch 42 as an interface, and the FC adapter 134 is connected to the FC switch 40 as an interface. In the program memory 132, a file management program 142, a data send/receive program 144, a stub management program 146, a metadata management program 148, and a node management program 150 are running as the various programs to be executed by the CPU 136, and information concerning these programs 142 to 150 is stored in the HDD 138.

The first storage apparatus 14 comprises an FC adapter 200, a controller 202, and an HDD 204 as the first memory device for storing data concerning a plurality of files 26, and the foregoing components are mutually connected via a system bus 206.

The FC adapter 200 is connected to the FC switch 40 as an interface. The HDD 204 is configured from one or two or more storage devices, and the storage area of the HDD 204 stores the file 26c, the metadata 28c, and the stub 80c. When the controller 202 receives an access request from the file server 12 or the archive server 16, it accesses the file 26c or the metadata 28c or the stub 30c in the HDD 204 and executes processing concerning such file 26c or metadata 28c or stub 30c according to the access request.

The second storage apparatus 18 is configured the same as the first storage apparatus 14 other than configuring a second memory device as the migration destination of data stored in the first storage apparatus 14, and comprises an FC adapter, a controller, an HDD, and a system bus (all not shown). When the controller receives an access request from the file server 12 or the archive server 16, it accesses the file 26e or the metadata 28e or the stub 30e in the HDD 204 according to the access request, and executes processing related to the file 26e or the metadata 28e or the stub 30e.

Meanwhile, in the program memory 70 of the file server 12, a file management program 80, a data send/receive program 82, a stub management program 84, a metadata management program 86, and a migration program 88 are running based on the execution of the CPU 74.

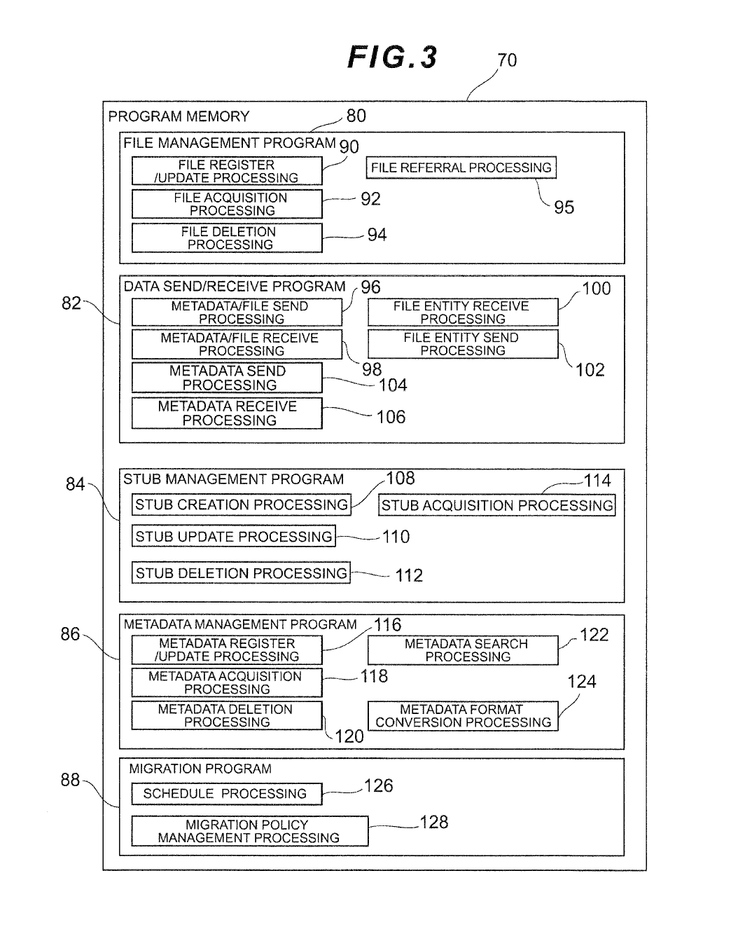

When the CPU 74 executes the respective programs, processing as shown in FIG. 3 is performed. For example, if the CPU 74 executes the file management program 80, the file registration/update processing 90, the file acquisition processing 92, the file deletion processing 94, and the file referral processing 95 are executed, and, when the CPU 74 executes the data send/receive program 82, the metadata/file send/receive processing 96, the metadata/file receive processing 98, the file entity receive processing 100, the file entity send processing 102, the metadata send processing 104, and the metadata receive processing 106 are performed.

Here, the file registration/update processing 90 is the processing of registering the file 26, which was input together with the file registration/update processing request 24, in the first storage apparatus 14.

The file referral processing 95 is the processing of searching for the file 26 designated in the file referral request 32 based on the metadata 28 and referring to the corresponding file 26 upon receiving the file referral request 32 from the referring client 22.

The file acquisition processing 92 is the processing of reading the file 26 that was referred to in the file referral processing 95 as the referral target file from the first storage apparatus 14.

The file deletion processing 94 is the processing of deleting the file 26 stored in the storage apparatus 14 that is managed by the file server 12 after the migration is executed.

The metadata/file send processing 96 is the processing of sending the migration target metadata 28 and file 26 to the archive server 16 during the execution of migration.

The metadata/file receive processing 98 is the processing of receiving the metadata 28 and the file 26 sent from the archive server 16, calculating the hash value concerning the received file 26, confirming whether such hash value coincides with the hash value in the metadata 28, and guaranteeing that the contents have not been changed.

The file entity receive processing 100 is the processing for requesting the archive server 16 to send the file entity with the stub 30 as the argument.

The file entity send processing 102 is the processing of acquiring, from the first storage apparatus 14, the file 26 corresponding to the stub 30 that was designated by the archive server 16 using the argument, and sending that file 26 to the archive server 16.

The metadata send processing 104 is the processing of sending only the metadata 28 to the archive server 16.

The metadata receive processing 106 is the processing of receiving the metadata 28 that was sent from the archive server 16.

When the CPU 74 executes the stub management program 84, the stub creation processing 108, the stub update processing 110, the stub deletion processing 112, and the stub acquisition processing 114 are performed, and, when the CPU 74 executes the metadata management program 86, the metadata registration/update processing 116, the metadata acquisition processing 118, the metadata deletion processing 120, the metadata search processing 122, and the metadata format conversion processing 124 are performed. In addition, when the CPU 74 executes the migration program 88, the migration processing 126 and the migration policy management processing 128 are performed.

Here, the stub creation processing 108 is the processing of creating the stub 30 for retaining the referral information to the file storage destination, and the processing for creating the stub 30 during the execution of migration to the archive server 16.

The stub update processing 110 is the processing of updating the stub 30 retaining the referral information (referral information for accessing the file storage destination) to the file storage destination, and the processing for updating the contents of the stub 30 when the referral information for accessing the file 26 stored in the second storage apparatus 18 has been changed.

The stub deletion processing 112 is the processing of deleting the unwanted stub 30, and the processing of the deleting the stub 30 if the file 26 registered in the second storage apparatus 18 is deleted.

The stub acquisition processing 114 is the processing of acquiring the referral information to the file storage destination that is retained in the stub 30.

The metadata registration/update processing 116 is the processing of registering and updating the metadata 28 added to the file 26 during the file registration in the first storage apparatus 14, and is the processing of newly registering the metadata 28 when newly creating a file 26, and updating the updated metadata 28 when updating the file 26.

The metadata acquisition processing 118 is the processing of reading the metadata 28 from the first storage apparatus 14.

The metadata deletion processing 120 is the processing of deleting the metadata 28 at the timing of deleting the file. Nevertheless, if the stub 30 is to be left and the original file 26 is to be deleted after migrating the file entity of the file 26 to the archive server 16, it is also possible to leave the metadata 20 of the deleted file 26.

The metadata search processing 122 is the processing of searching for information such as the update date and time and file size stored in the metadata 28 at the timing of file referral or migration execution. Processing of extracting the file 26 that conforms to the condition is performed based on this processing result.

The metadata format conversion processing 124 is the processing of converting the contents of the metadata 28 into a format; for instance, an XML format that is adopted by the archive server 16.

The scheduler processing 126 is the processing of confirming the status of the file 26 conforming to the migration condition for each designated time, and starting the migration if a file 26 conforming to the migration condition exists.

The migration policy management processing 128 is processing for managing whether a file 26 conforming to the migration condition exists in the first storage apparatus 14.

Although these programs 80 to 88 run on the program memory 70, information concerning the respective programs 80 to 88 is stored in the HDD 76.

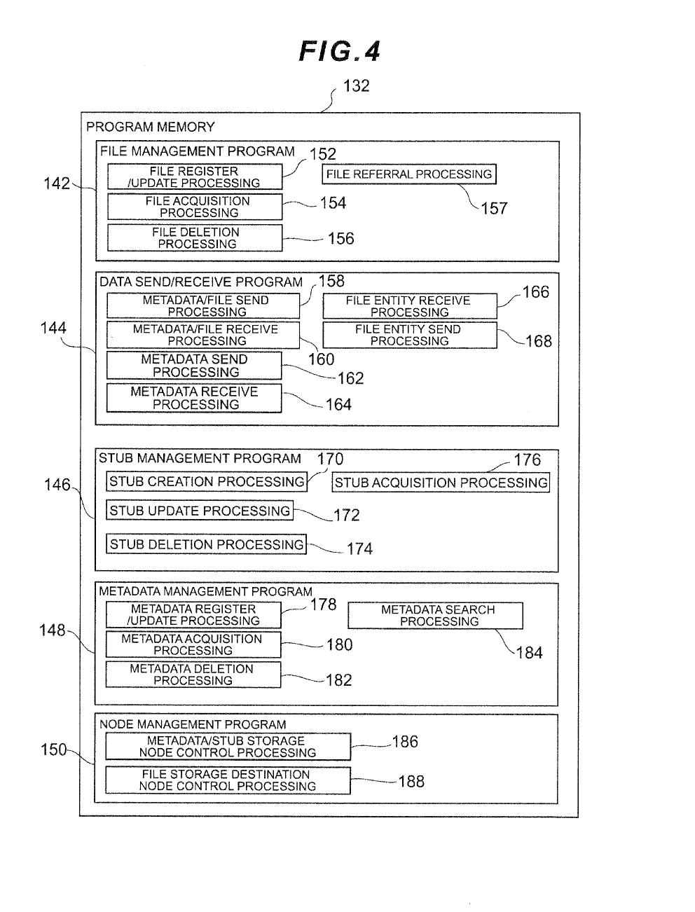

When the CPU 136 of the archive server 16 executes the various programs, the various types of processing shown in FIG. 4 are performed.

For example, when the CPU 136 executes the file management program 142, the file update processing 152, the file acquisition processing 154, the file deletion processing 156, and the file referral processing 157 are performed, and, when the CPU 136 executes the data send/receive program 144, the metadata/file send/receive processing 158, the metadata/file receive processing 160, the metadata send processing 162, the metadata receive processing 164, the file entity receive processing 166, and the file entity send processing 168 are performed.

Moreover, when the CPU 136 executes the stub management program 146, the stub creation processing 170, the stub update processing 172, the stub deletion processing 174, and the stub acquisition processing 176 are performed, and, when the CPU 136 executes the metadata management program 148, the metadata registration/update processing 178, the metadata acquisition processing 180, the metadata deletion processing 182, and the metadata search processing 184 are performed. In addition, when the CPU 136 executes the node management program 150, the metadata/stub storage node control processing 186, and the file storage destination node control processing 188 are performed.

Among the foregoing processes 152 to 188, the archive server 16 takes the initiative in performing the processes 152 to 184 in substitute of the file server 12, and these processes are the same as processes 90 to 120 other than that the access target is changed from the storage apparatus 14 to the storage apparatus 18, and the explanation of the foregoing processes is omitted.

Here, the metadata/stub storage node control processing 186 is the processing of determining the storage destination of the metadata 28 and the stub 30 based on the hash value of the file 26.

The file storage destination node control processing 188 is the processing of determining the storage destination of the file 26 based on the unused space of the node.

The details regarding the foregoing processes will be explained later. The node management program 150 runs on only one node; for instance, on the node 1, and does not run on the other nodes in the archive server 16. If the archive server 16 is configured from a single node, the node management program 150 will no longer be required. Moreover, although the file server 12 is shown as being configured from a single node, the file server 12 may also be configured from a plurality of nodes or take on a cluster configuration.

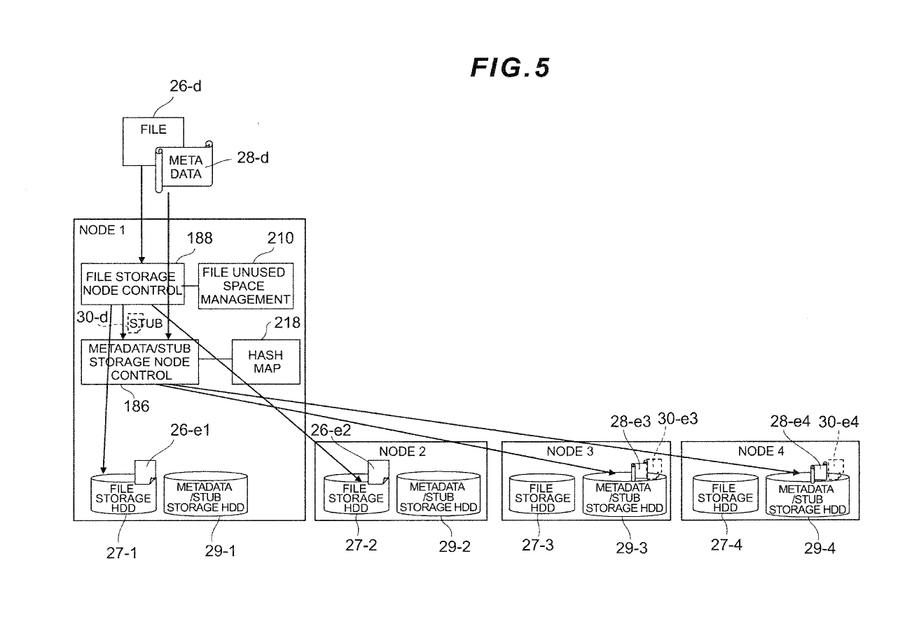

The operation of registering the file 26 and the metadata 28 in the archive server 16 is now explained with reference to FIG. 5. The following processing is performed when configuring the archive server 16 with the nodes 1 to 4 and registering the file 26 and the metadata 28 in any one of the nodes among the nodes 1 to 4.

For example, if the file 26-d and the metadata 28-d are input to the node 1, the node 1 executes the file storage destination node control processing 188 based on the contents of the file unused space management 210, and determines the registration destination of the file 26-d based on the usage rate of the respective nodes.

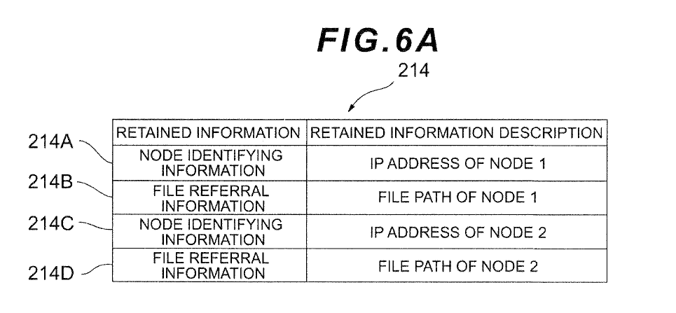

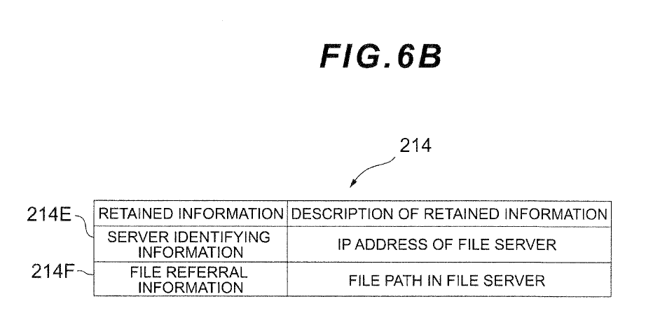

For instance, if the node 1 selects the node 1, which is the self node, as the node with the lowest usage rate among the nodes based on the management result of the unused space of the file 26-d, it registers the file 26-d in the file storage HDD 27-1 of the selected node 1 as the file 26-e1, and copies the file 26-d to the file storage HDD 27-2 of the node 2 as the file 26-e2 in order to enable continuous operation even upon the failure of the node 1. In the foregoing case, the node 1 creates the retained information 214 of the stub 30-d as shown in FIG. 6A and executes the metadata/stub storage node control processing 186 to the stub 30-d that was created from the metadata 28-d.

The retained information 214 of the stub 30-d includes, as shown in FIG. 6A, node identifying information 214A, file referral information 214B, node identifying information 214C, and file referral information 214D. The node identifying information 214A is configured from an IP (Internet Protocol) address of the node 1 storing the file 26-e1, the file referral information 214B is configured from the file path of the node 1 storing the file 26-e1, the node identifying information 214C is configured from the IP address of the node storing the file 26-e2 as a result of the copying process, and the file referral information 214D is configured from the file path of the node 2 storing the file 26-e2 as a result of the copying process.

The node 1 thereafter refers to the hash map 218 upon executing the metadata/stub storage node control processing 186.

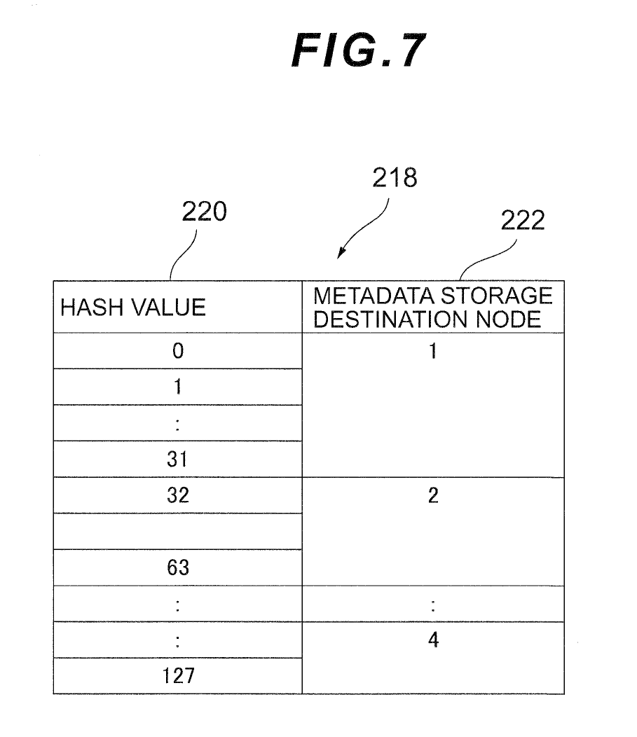

The hash map 218 is configured, as shown in FIG. 7, from a hash value field 220, and a metadata storage destination node field 222. Each entry of the hash value field 220 stores the numerical value of 0 to 127 as the hash value. Four entries of the metadata storage destination node field 222 are configured in correspondence to the blocks obtained by quartering the hash value of 0 to 127, and the four entries stores “1” to “4” as the number showing the metadata storage destination node.

In the foregoing case, if the hash value is “0 to 31” the metadata storage destination node will be the node 1, if the hash value is “32 to 63” the metadata storage destination node will be the node 2, if the hash value is “64 to 95” the metadata storage destination node will be the node 3, and if the hash value is “96 to 127” the metadata storage destination node will be the node 4.

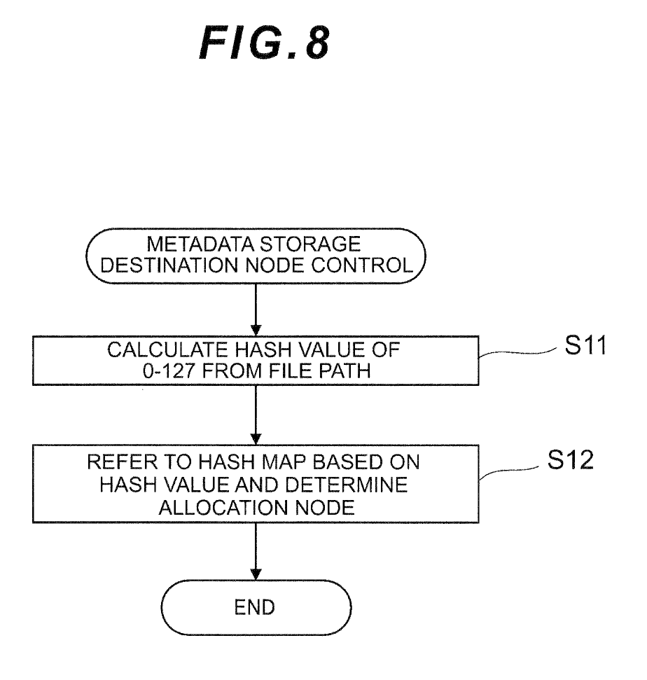

The processing of searching for the hash map 218 and determining the metadata storage destination node is now explained with reference to the flowchart of FIG. 8.

Foremost, upon searching for the hash map 218 and determining the metadata storage destination node, the node 1 calculates the hash value of 0 to 127 from the file path belonging to the metadata 28 (S11), refers to the hash map 218 based on the calculated hash value, and determines the allocation node to become the metadata storage destination node according to the hash value (S12).

For instance, if the node 1 calculates the hash value as 64 to 95, it selects the node 3 and determines the selected node 3 to be the allocation node, registers the metadata 28-e3 in the node 3, and registers the stub 30-e3 upon associating it with the metadata 28-e3. Moreover, the node 1 copies the metadata 28-e3 and the stub 30-e3, which are registered in the node 3, to the node 4, and registers them as the metadata 28-e4 and the stub 30-e4 in order to enable the continuous operation even during the failure of the node 3.

In the foregoing processing, although the processing of determining the node for storing the file 26-d among the respective nodes 1 to 4 was performed in the archive server 16, the following processing or, in the other Examples, the processing of determining the node for managing the file 26-d and the metadata 28-d may be omitted.

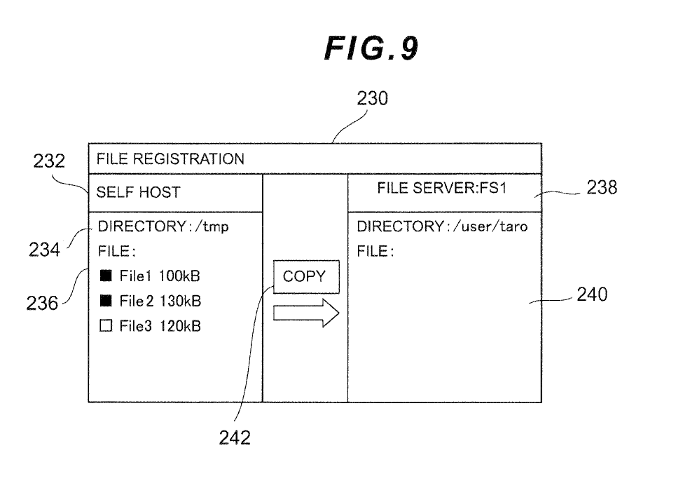

The processing during the file registration/update is now explained with reference to FIG. 9 to FIG. 11.

Upon performing the file registration/update processing, the registered client 20 displays a file registration screen 230 based on the operation of the operator as shown in FIG. 9. The self host area 232 in the file registration screen 230 displays information concerning the directory 234 and the file 236 of the registered client 20, the file server area 238 displays the name of the file server 12, and the directory area 240 displays information concerning the directory of the file server 12.

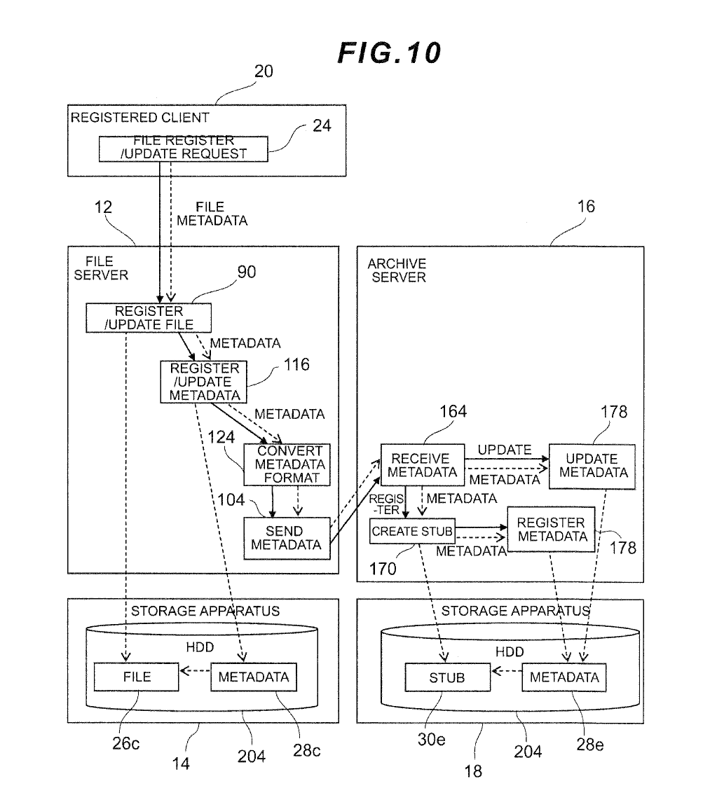

When the operator thereafter selects the file to be registered or updated and operates the button 242, as shown in FIG. 10, the file registration/update request 24 is sent from the registered client 20 to the file server 12. Here, the file 26a including the metadata 28a is added to the file registration/update request 24. In the foregoing case, CIFS (Common Internet File System), NFS (Network File System) or the like is used as the protocol.

When the file server 14 receives the file registration/update request 24, it sequentially executes the file registration/update processing 90, the metadata registration/update processing 116, the metadata format conversion processing 124, and the metadata send processing 104, stores the file 26a as the file 26c, received together with the file registration/update request 24 in the HDD 204 of the first storage apparatus 14, and also stores the metadata 28a as the metadata 28c in the HDD 204. Here, the file server 14 performs processing for associating the file 26c and the metadata 28c and sending the metadata 28c to the archive server 16. The protocol in the foregoing case is HTTP (Hypertext Transfer Protocol) or the like.

Meanwhile, when the metadata 28c is sent from the file server 12 to the archive server 16, the archive server 16 that received the metadata 28c sequentially executes the metadata receive processing 164, the stub creation processing 170, and the metadata registration/update processing 178, stores the stub 30e that was created based on the registered metadata 28e in the HDD 204 of the second storage apparatus 18, and executes processing for registering the metadata 28c in the HDD 204 or executes update processing to the registered metadata 28e. The series of processing flows in the foregoing case are shown with solid lines and the series of data flows are shown with broken lines.

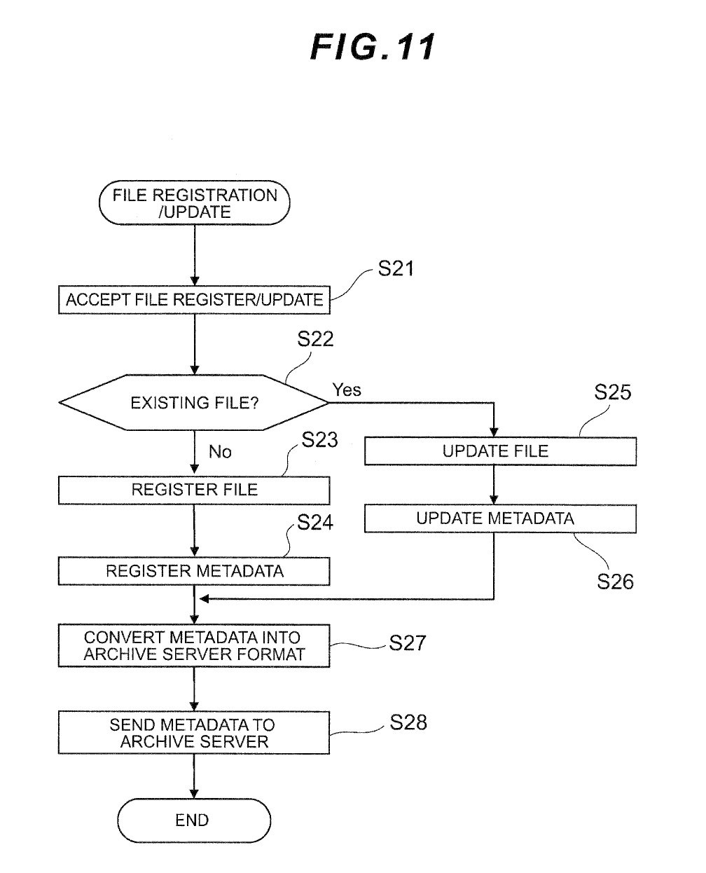

The specific contents of the file registration/update processing are now explained with reference to the flowchart of FIG. 11.

Foremost, when the CPU 74 of the file server 12 receives the file registration/update request 24 from the registered client 20, it accepts the file registration/update request 24 (S21), and executes the file registration update processing 90 and the metadata registration/update processing 116. Here, the CPU 74 determines whether the file 26a sent from the registered client 20 is an existing file (S22), registers the file 26a in the HDD 204 of the first storage apparatus 14 upon determining that it is not an existing file (S23), and registers the metadata 28a added to the file 26a in the HDD 204 of the first storage apparatus 14 (S24).

Meanwhile, if the CPU 74 determines that the file 26a that was sent from the registered client 20 is an existing file, it performs processing of updating the information of the file 26c registered in the HDD 204 of the first storage apparatus 14 (S25), subsequently performs processing of updating data concerning the metadata 28c registered in the HDD 204 of the first storage apparatus 14 (S26), and proceeds to the processing of step S27.

At step S27, the CPU 74 executes the metadata format conversion processing 124, converts the metadata 28c into a format; for instance, an XML (Extensible Markup Language) format adopted by the archive server 16, sends the converted metadata 28c to the archive server 16 (S28), and thereafter ends the processing in this routine.

Here, when the CPU 74 is to store the metadata 28c in the first storage apparatus 14, as shown in FIG. 12, it manages the metadata 28 according to the metadata management table 250 stored in the HDD 76.

The metadata management table 250 is configured from an i-node field 252, a file path field 254, a size field 256, a file status field 258, a hash value field 260, a permission field 262, an ACL (Access Control List) field 264, an update date and time field 266, a stub status field 268, and a stub path field 270.

Each entry of the i-node field 252 stores an identifier of the file 26 for managing the metadata 28 with the i-node as the key. Each entry of the file path field 254 stores the directory “dir1” and the file name “file1,” “file2,” . . . of the file storage destination. Each entry of the size field 256 stores, for instance, 100 kB, 23 kB or the like as the size of each file 26c. Each entry of the file status field 258 stores, as information concerning the status of the file 26c, the information of “Yes” if the file 26c exists in the first storage apparatus 14, and stores the information of “No” if the file 26c does not exist in the first storage apparatus 14.

Each entry of the hash value field 260 stores the hash value “2222,” “3423” or the like of each file 26c. Each entry of the permission field 262 stores the value of the file permission based on the POSIX (Portable Operating System Interface for Computer environments) standard. Each entry of the ACL field 264 stores information concerning the access control list which defines the access authority of each user. Each entry of the update date and time field 266 stores information concerning the date and time that the respective files 26c were updated.

The stub status field 268 stores the information of “Yes” if the stub 30c exists in the first storage apparatus 14 in correspondence to the respective files 26c, and stores the information of “No” if the stub 30c does not exist in the first storage apparatus 14. Each entry of the stub path field 270 stores information concerning the path of the storage destination of the stub 30c corresponding to the respective files 26c.

The update date and time field 266 may also be configured as a time stamp field, and the time stamp field may be configured from one among atime (last access time), mtime (last change time), and ctime (last status change time).

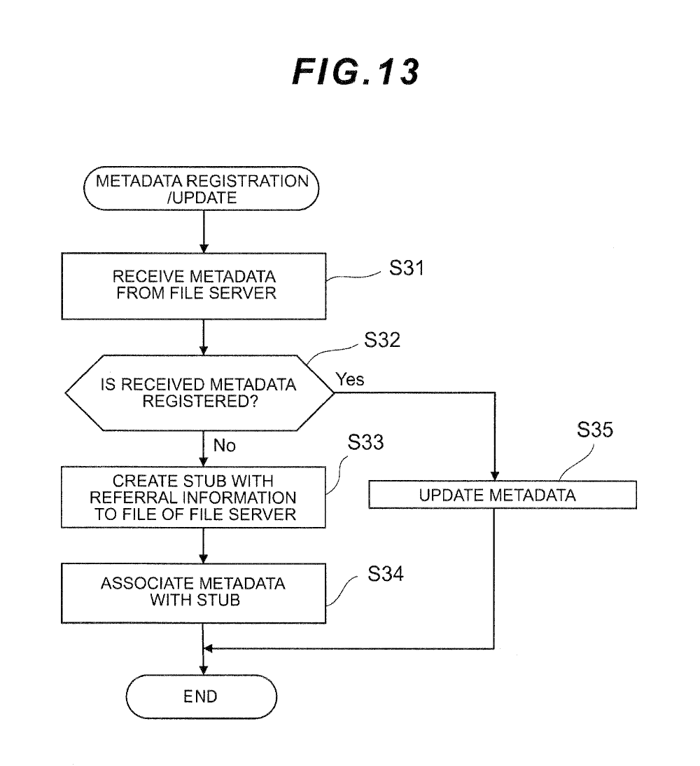

The metadata registration/update processing 178 is now explained with reference to FIG. 13.

Foremost, the CPU 136 of the archive server 16 performs the metadata receive processing 164 of receiving the metadata 28c from the file server 12 (S31), and thereafter starts the metadata registration/update processing 178. Here, the CPU 136 determines whether the received metadata 28c has been registered (S32), creates the stub 30e as the referral information for referring to the file 26c stored in the first storage apparatus 14 upon determining that it has been registered (S33), associates the created stub 30e and the received metadata 28c and registers this in the HDD 204 of the second storage apparatus 18 (S34), and thereby ends the processing of this routine.

Meanwhile, if the CPU 136 determines that the metadata 28c that was received at step S32 has been registered, it performs processing for updating the metadata 28e that is registered in the HDD 204 (S35), and thereby ends the processing of this routine.

Here, the stub 30 is referral information (referral information for accessing the file 26 stored in the migration source) for referring to the file 26c stored in the first storage apparatus 14. Nevertheless, in this Example, when the file 26c stored in the first storage apparatus 14 is migrated to the second storage apparatus 18 pursuant to the migration, the stub 30e is sometimes used as referral information (referral information for accessing the file 26 stored in the migration destination) for referring to the file 26e stored in the second storage apparatus 18. The stub 30c is also sometimes used as the referral information for the file server 12 to refer to the file 26e stored in the second storage apparatus 18.

Here, if the file 26c stored in the first storage apparatus 14 is set as the migration target file to be migrated, and the stub 30c is created from the metadata 28c corresponding to the migration target file before the migration target file is migrated, the retained information of this stub 30c will be configured as shown in FIG. 6B.

In FIG. 6B, the retained information 214 of the stub 30c that was created before the migration comprises server identifying information 214E, and file referral information 214F. The server identifying information 214E is configured from an IP address of the file server 12, and the file referral information 214F is configured from a file path in the file server 12.

Thus, if the file 26c as the referral target file is stored in the first storage apparatus 14, as a result of the using the retained information 214 comprising the server identifying information 214E and the file referral information 214F as the referral information retained by the stub 30e, the archive server 16 will be able to refer to the file 26c of the first storage apparatus 14 based on the retained information 214 of the stub 30e.

With the archive server 16, the CPU 136 is managing the metadata 28e according to the metadata management table.

FIG. 14A shows the configuration of the metadata management table 280 under the control of the CPU 136. The metadata management table 280 is configured from an i-node field 282, a file path field 284, a size field 286, a file status field 288, a hash value field 290, a permission field 292, an extended metadata field 294, an update date and time field (mtime) 296, a stub status field 298, and a stub path field 300, and stored in the HDD 138.

Each entry of the i-node field 282 stores information of the identifier of the respective files 26e, and each entry of the file path field 284 stores the directly and file name of the file storage destination. Each entry of the size field 280 stores information concerning the size of the respective files 26e. Each entry of the file status field 288 stores the information of “Yes” if the respective files 26e exist in the second storage apparatus 18, and stores the information of “No” if the respective files 26e do not exist in the second storage apparatus 18. Each entry of the hash value field 290 stores information concerning the hash value of the respective files 26.

Each entry of the permission field 292 stores information concerning the file permission based on the POSIX standard. Each entry of the extended metadata field 294 stores information concerning ACL as the extended metadata; for instance, information 295 converted into text of an XML format as shown in FIG. 14B.

The update date and time field 296 stores information concerning the date and time that the respective files 26e were updated. Each entry of the stub status field 298 stores the information of “Yes” if the stub 30e exists in the second storage apparatus 18 and stores the information of “No” if the stub 30e does not exist in the second storage apparatus 18. Each entry of the stub path field 300 stores information showing the path of the storage destination of the stub 30e.

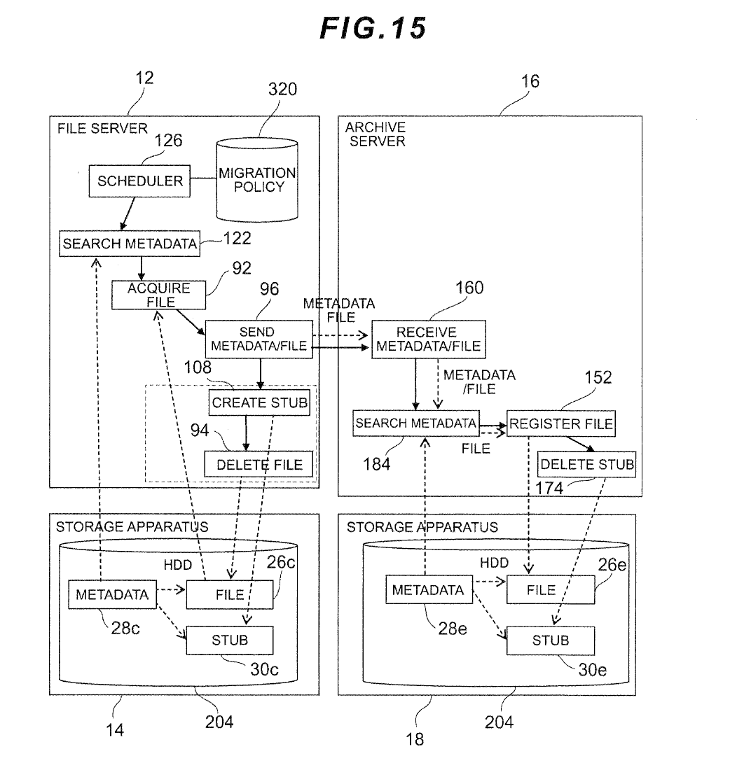

The processing during the execution of migration is now explained with reference to FIG. 15.

The CPU 74 of the file server 12 refers to the migration policy 320 upon executing the migration processing, executes the scheduler processing 126 based on the referral result, and thereafter performs the metadata search processing 122.

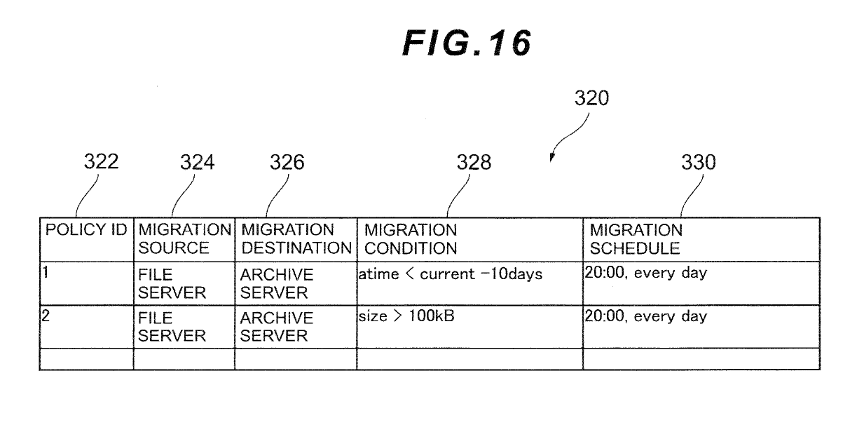

The migration policy 320 is configured in a table format as shown in FIG. 16, and is configured from a policy ID field 322, a migration source field 324, a migration destination field 326, a migration condition field 328, and a migration schedule field 330.

Each entry of the policy ID field 322 stores a numerical value such as “1” or “2” as the identifier of the policy. Each entry of the migration source field 324 stores, as the name of the migration source, for instance, the name of the file server 12. Each entry of the migration destination field 326 stores, as the name of the migration destination, for instance, the name of the archive server 16.

Each entry of the migration condition field 328 stores information concerning the migration condition; for instance, information showing whether the last access time is less than 10 days from the current time or information showing whether the size of the file 26c is 100 kB or larger. Each entry of the migration schedule field 330 stores, as information concerning the migration schedule, for instance, information to the effect of checking the file at 20:00 on a daily basis.

Here, if the policy 1 of the policy ID field 322 is selected, the file 26c is checked at 20:00 on a daily basis, and, if there is no access for 10 days, migration is performed with the file server 12 as the migration source and the archive server 16 as the migration destination.

If the policy 2 of the policy ID field 322 is selected, the file 26c is checked at 20:00 on a daily basis, and, if the size of the file 26c is larger than 100 kB, migration is performed with the file server 12 as the migration source and the archive server 16 as the migration destination. As the timing of starting the migration, the timing that the clock of the timer reaches a fixed time, the timing that the storage usage reaches a setting value, or the timing that the access frequency by the file server 12 falls below a setting value may be used.

Subsequently, the CPU 74 executes the metadata search processing 122, searches for the metadata 28c stored in the first storage apparatus 14, and executes the file acquisition processing 92 based on the search result. For example, the CPU 74 determines the file 26c that conforms to the condition indicated in the migration policy as the migration target file based on the update date and time stored in the update date and time field 296 of the metadata 28c, and executes the processing of acquiring the determined file 26c. After acquiring the file 26c, the CPU 74 executes the metadata/file send processing 96, and sends the metadata 28c and the file 26c to the archive server 16.

Meanwhile, the CPU 136 of the archive server 16 executes the metadata/file receive processing 160, receives the metadata 28c and the file 26c sent from the file server 12, executes the metadata search processing 184 based on the received metadata 28c and the file 26c, searches for the metadata 28e from the second storage apparatus 18, executes the file registration processing 152 based on the search result, and registers the file 26e in the second storage apparatus 18.

In addition, if the file path added to the received metadata 28c and the file path added to the metadata 28e obtained as a result of searching the second storage apparatus 18 coincide, the CPU 136 changes the contents of the stub 30e to the referral information to the registered file 26e, and, if the file paths do not coincide, the CPU 136 newly creates a stub 30e, and registers the contents of the created stub 30e as referral information for the metadata 28e.

Pursuant to the file 26e being registered in the second storage apparatus 18, the CPU 136 may execute the stub deletion processing 174 and delete the stub 30e that is registered in the second storage apparatus 18.

After the migration is executed, the post-migration information; for instance, referral information showing the storage location (second storage apparatus 18) of the file 26e (referral information for accessing the file 26 stored in the migration destination) is sent from the archive server 16 to the file server 12.

Here, the CPU 74 of the file server 12 receives the referral information sent from the archive server 16, executes the stub creation processing 108 based on the received referral information, creates the stub 30c, stores the created stub 30c in the first storage apparatus 14, and associates the created stub 30c and the metadata 28c. The CPU 74 further executes the file deletion processing 94 based on information concerning the created stub 30c, and deletes the file 26c that is registered in the first storage apparatus 14. The series of processing flows are shown with solid line arrows and the series of data flows are shown with broken line arrows.

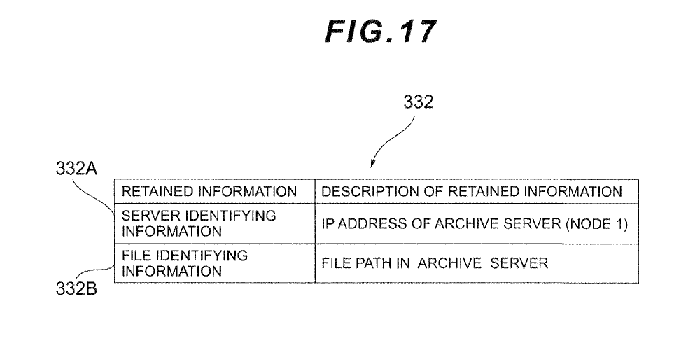

Here, the retained information of the stub 30c that is registered in the first storage apparatus 14 after the migration is executed is shown in FIG. 17.

The retained information 332 of the stub 30c comprises server identifying information 332A and file identifying information 332B. The server identifying information 332A is configured from an IP address of the archive server 16, and the file identifying information 332B is configured from a file path in the archive server.

Thus, if the file 26c as the referral target file is migrated to the second storage apparatus 14, and a file referral request is input to the file server 12 when the file 26c as the referral target file does not exist in the first storage apparatus 14, as a result of sending the retained information 332 comprising the server identifying information 332A and file identifying information 332B as the referral information retained by the stub 30c from the file server 12 to the file referral requestor, the file referral requestor is able to refer to the file 26e of the second storage apparatus 18 based on the retained information 332 of the stub 30c.

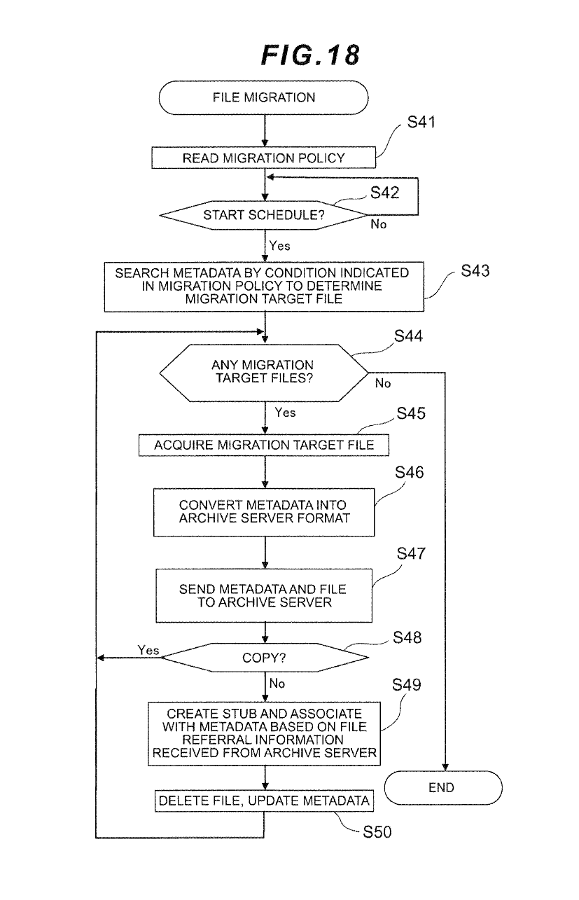

The migration processing in the file server 12 is now explained with reference to the flowchart of FIG. 18.

The CPU 74 of the file server 12 reads information of the migration policy 320 (S41), determines whether it is time to start the schedule (S42), and, for instance, upon selecting policy 1, it starts the processing at 20:00 on a daily basis, searches for the metadata 28c according to the migration condition, and determines the migration target file (S43).

Here, for example, if the CPU 136 selects policy 1, the CPU 74 checks the file at 20:00 on a daily basis, determines a file 26c which has not been accessed for 10 days to be the migration target file, determines whether a migration target file exists in the files 26c stored in the first storage apparatus 14 (S44), ends the processing of this routine upon determining that there is no migration target file, and acquires the migration target file from the first storage apparatus 14 upon determining that there is a migration target file (S45).

Subsequently, the CPU 74 converts the metadata 28c that was searched in the metadata search processing 122 into a format such as an XML format that is adopted by the archive server 12 (S46), sends the metadata 28c that was subject to format conversion and the file 26c that was acquired from the first storage apparatus 14 to the archive server 16 (S47), determines whether it is time to perform copy processing (S48), returns to the processing at step S44 if it is time to perform copy processing. Meanwhile, if it is not time to perform copy processing; that is, if it time to perform post-migration processing, the CPU 74 performs processing for creating the stub 30c based on the file referral information (file referral information showing that the migration target file has been stored in the second storage apparatus 18) that was received from the archive server 16, and associates the created stub 30c and the metadata 28c (S49).

The CPU 74 thereafter deletes the file 26c that become the migration target file pursuant to the migration of the migration target file, performs processing of updating the metadata 28c corresponding to that file 26c (S50), returns to the processing at step S44, and then repeats the processing of step S44 to S50.

Specifically, at steps S49 and S50, the CPU 74 creates the retained information 332 of the stub 30c showing that the migration target file has been stored in the second storage apparatus 18 as the retained information of the stub 30c pursuant to the storage of the migration target file in the second storage apparatus 18. Further, the CPU 74 performs processing for changing the metadata 28c corresponding to the migration target file; for instance, in order to reflect the fact that the file 26c as the migration target file has been deleted in the metadata 28c, it changes the file status field 258 of the metadata management table 250 shown in FIG. 12 from “Yes” to “No.”

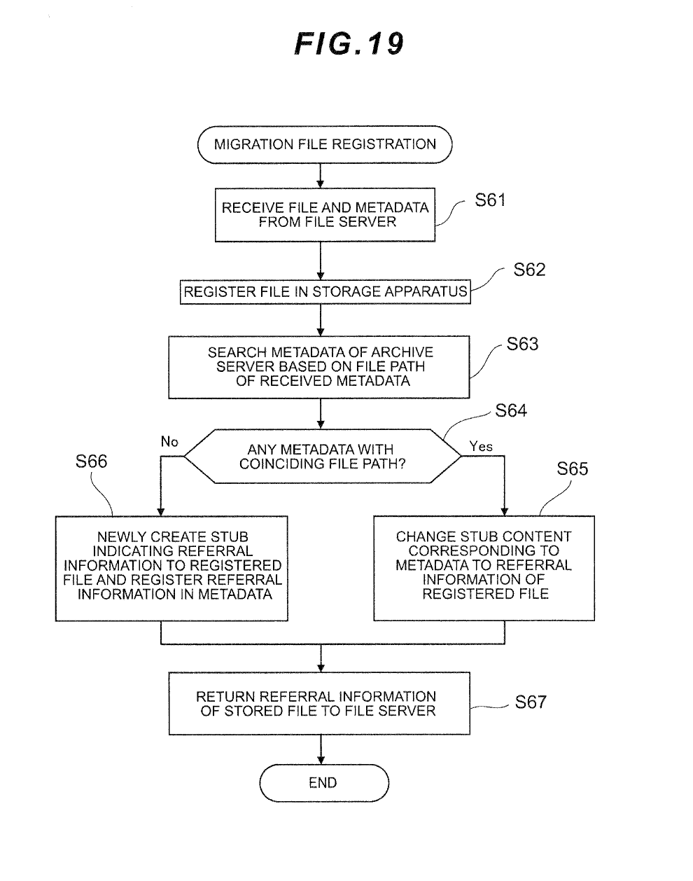

The registration processing of the migration target file in the archive server 16 is now explained with reference to the flowchart of FIG. 19.

The CPU 136 of the archive server 16 receives the file (migration target file) 26c and the metadata 28c from the file server 12 (S61), registers the received file 26c and the metadata 28c in the second storage apparatus 18 (S62), and searches for the metadata 28c in the second storage apparatus 18 according to the file path of the received metadata 28e (S63).

Subsequently, the CPU 136 determines whether the file path of the received metadata 28c and the file path of the metadata 28e obtained as a result of searching the second storage apparatus 18 coincide (S64), and, if the CPU 136 determines that the file paths coincide, it changes the contents of the stub 30e corresponding to the metadata 28e stored in the second storage apparatus 18 to the referral information for referring to the file 26e registered in the second storage apparatus 18 (S65).

Meanwhile, if the CPU 136 determines at step S64 that the file paths do not coincide, it newly creates a stub 30e indicating the referral information for referring to the file 26e registered in the second storage apparatus 18, and registers the contents of the newly created stub 30e in the metadata 28e with, for example, the stub path as the referral information (S66).

The CPU 136 thereafter returns the referral information for referring to the file 26e stored in the second storage apparatus 18; that is, the referral information showing that the file 26e is stored in the second storage apparatus 18 (referral information for accessing the file 26 stored in the second storage apparatus 18) to the file server 12 (S67), and thereby ends the processing of this routine.

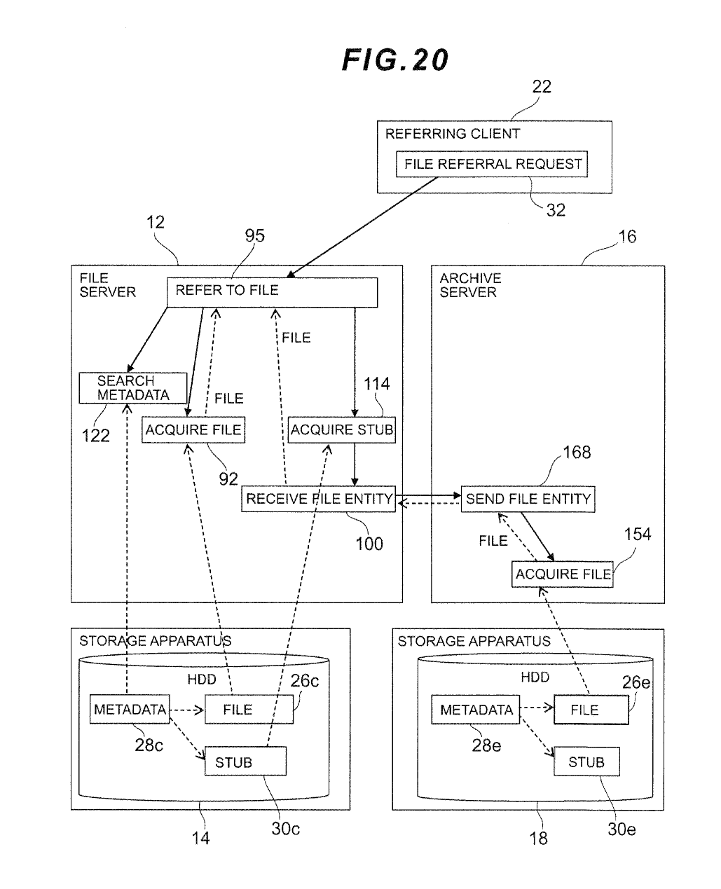

The processing during the file referral in the file server 12 is now explained with reference to FIG. 20.

Upon referring to the files in the file server 12, the referring client 22 sends the file referral request 32 to the file server 12 based on the operation of the operator.

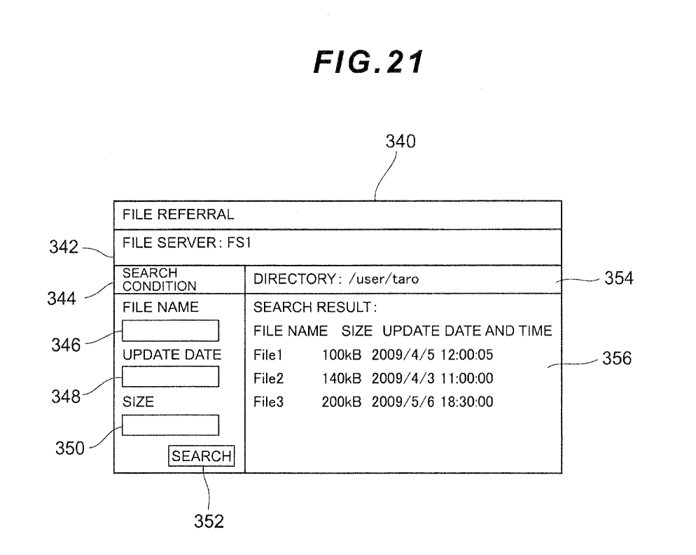

Here, the display example of the file referral screen 30 in the referring client 22 is shown in FIG. 21. In FIG. 21, the file referral screen 340 is configured from a file server display area 342, a search condition display area 344, a file name insertion area 346, an update date insertion area 348, a size insertion area 350, a search button 352, a directory display area 354, and a search result display area 356.

When the operator inserts the file name, the update date, and the size in their respective insertion areas and thereafter operates the search button 352, the file referral request 32 is sent from the referring client 22 to the file server 12, and, as the search result of the file server 12, the file name, the size, and the update date and time are displayed on the search result display area 356.

When the CPU 74 of the file server 12 subsequently receives the file referral request 32, the CPU 74 starts the file referral processing 95 shown in FIG. 20, and executes the metadata search processing 122. Here, the CPU 74 searches for the metadata 28 based on the file path of the referral target file 26 designated in the file referral request 32, determines whether the referral target file 26 exists in the first storage apparatus 14 based on the search result, and executes the file acquisition processing 92 upon determining that the referral target file 26 exists.

The CPU 74 thereafter acquires the referral target file 26 from the first storage apparatus 14, and provides the acquired referral target file 26 to the referring client 22.

Meanwhile, if the referral target file 26 does not exist in the first storage apparatus 14, the CPU 74 executes the stub acquisition processing 114 for acquiring the stub 30c from the first storage apparatus 14, and sends a request to the archive server 16 for acquiring the referral target file 26 based on the information of the acquired stub 30c.

Subsequently, in response to the request from the file server 12, the CPU 136 of the archive server 16 executes the file acquisition processing 154, acquires the referral target file 26 from the second storage apparatus 18, and executes the file entity send processing 168 for sending the acquired referral target file 26 to the file server 12.

The CPU 74 of the file server 12 subsequently executes the file entity receive processing 100, receives the file 26e that was sent from the archive server 16, and provides the received file 26e as the referral target file to the referring client 22. The series of processing flows are shown with solid line arrows, and the series of data flows are shown with broken line arrows.

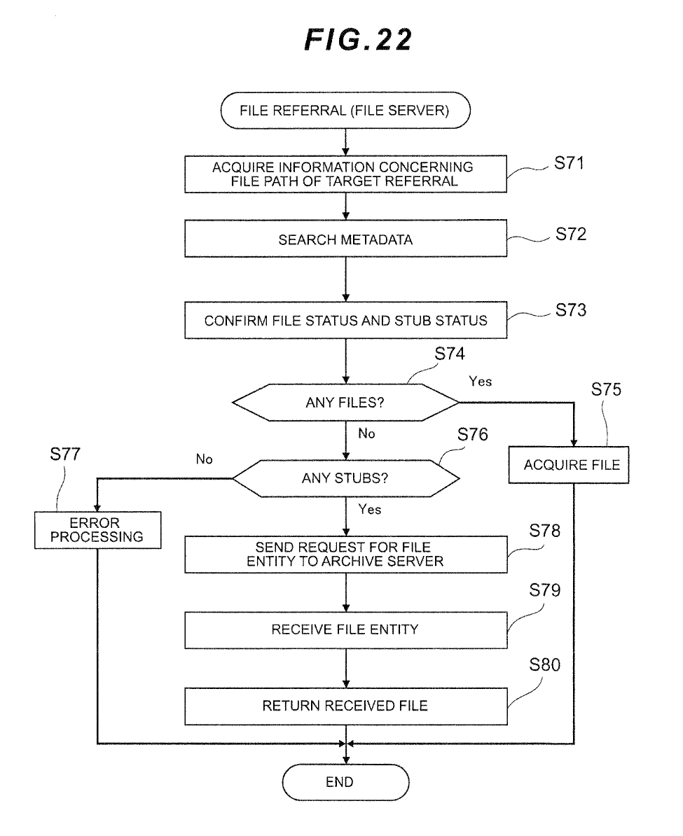

The file referral processing in the file server 12 is now explained with reference to the flowchart of FIG. 22. Foremost, when the CPU 74 of the file server 12 receives the file referral request 32 from the referring client 22, it acquires information concerning the file path of the referral target file 26 designated in the file referral request 32 (S71), searches for the metadata 28c in the first storage apparatus 14 based on the acquired information (S72), refers to the metadata management table 250 based on the search result, confirms the status of existence of the referral target file 26 and the status of existence of the stub 30c (S73), and determines whether there is the referral target file 26 (S74).

Specifically, the CPU 74 refers to the metadata management table 250 shown in FIG. 12, confirms the status of the file 26c and the status of the stub 30c, acquires the referral target file 26 among the files 26c in the first storage apparatus 14 according to the file path upon determining that the referral target file 26 exists (S75), and thereby ends the processing of this routine.

Meanwhile, if the CPU 74 determines that the referral target file 26 does not exist in the first storage apparatus 14, the CPU 74 determines whether there is a stub 30c (S76), executes error processing upon determining that a stub 30c does not exist (S77), and thereby ends the processing of this routine. Meanwhile, if the CPU 74 determines that a stub 30c exists, it outputs a request to the archive server 16 for sending the file entity of the referral target file 26 to the archive server 16 based on the retained information 332 of the stub 30c (S78).

The CPU 74 thereafter receives the file (referral target file) 26e registered in the second storage apparatus 18 from the archive server 16 (S79), returns the received file 26e as the referral target file to the referring client 22 (S80), and thereby ends the processing of this routine.

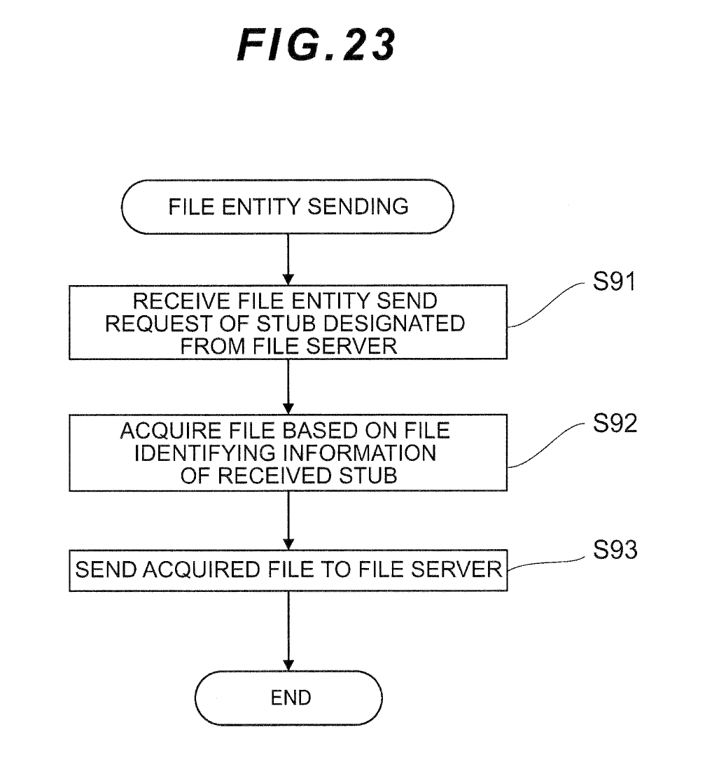

The file entity send processing in the archive server 16 is now explained with reference to the flowchart of FIG. 23.

Foremost, the CPU 136 of the archive server 16 receives the file entity send request of the designated stub 30c from the file server 12 (S91), acquires the file 26e from the second storage apparatus 18 based on the file identifying information 332B of the received stub 30c (S92), sends the acquired file 26e as the referral target file to the file server 12 (S93), and thereby ends the processing of this routine.

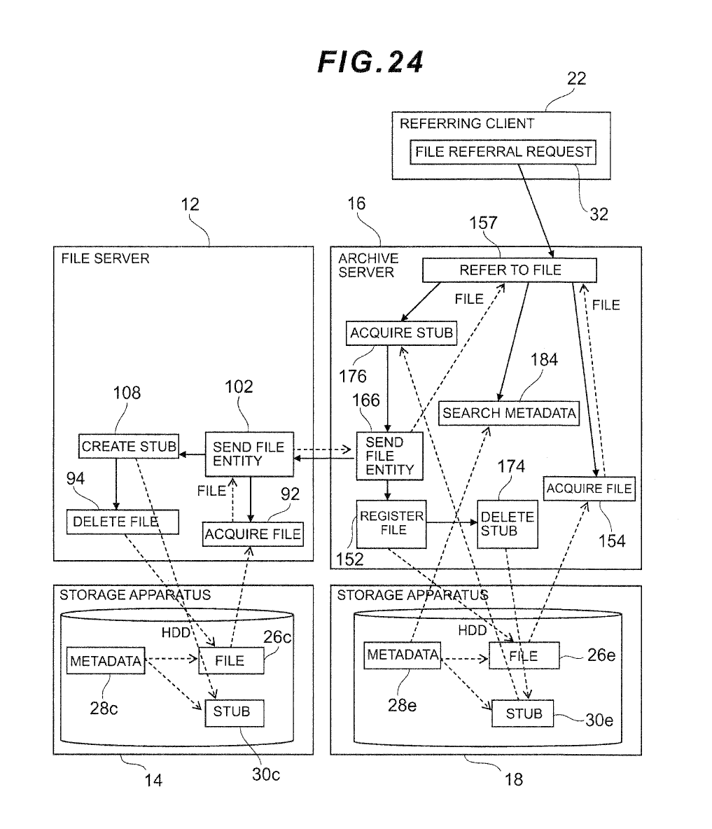

The processing during the file referral in the archive server 16 is now explained with reference to FIG. 24.

When the file referral request 32 is sent from the referring client 22, the CPU 136 of the archive server 16 receives the file referral request 32 from the referring client 22, and executes the file referral processing 157. Specifically, the CPU 136 acquired information concerning the file path of the referral target file 26 according to the search condition designated in the file referral request 32, and executes the metadata search processing 184 based on the acquired information. Here, the CPU 136 refers to the metadata management table 280 shown in FIG. 14A, searches for the metadata 28e corresponding to the referral target file 26, and confirms the status of the referral target file 26 and the status of the stub 30e.

If the referral target file 26 exists in the second storage apparatus 18, the CPU 136 executes the file acquisition processing 154, acquires the file 26e from the second storage apparatus 18, and provides the acquired file 26e to the referring client 22.

Meanwhile, if the referral target file 26 does not exist in the second storage apparatus 18, the CPU 136 executes the stub acquisition processing 176, acquires the stub 30e from the second storage apparatus 18, and sends a request to the file server 12 for acquiring the referral target file 26 from the file server 12 based on the file referral information 214F (FIG. 6B) of the acquired stub 30e.

In this response to this request, the CPU 74 of the file server 12 executes the file acquisition processing 92, acquires the referral target file 26 among the files 26c stored in the first storage apparatus 14, and executes the file entity send processing 102 as the processing for sending the acquired referral target file 26 to the archive server 16.

Here, pursuant to the sending of the referral target file 26 to the archive server 16, the CPU 74 executes the stub creation processing 108 for newly creating a stub 30c, and also executes the file deletion processing 94 for deleting the referral target file 26. The CPU 74 additionally changes the contents of the metadata 28c pursuant to the creation of the stub 30c.

Meanwhile, the CPU 136 of the archive server 16 that received the referral target file from the file server 12 executes the file entity receive processing 166, executes the file registration processing 152 for registering the received file 26c in the second storage apparatus 18, and registers the referral target file in the second storage apparatus 18. The CPU 136 thereafter executes the stub deletion processing 174 pursuant to the registration of the referral target file 26 in the second storage apparatus 18, and deletes the stub 30e. The series of processing flows are shown with solid line arrows and the series of data flows are shown with broken line arrows.

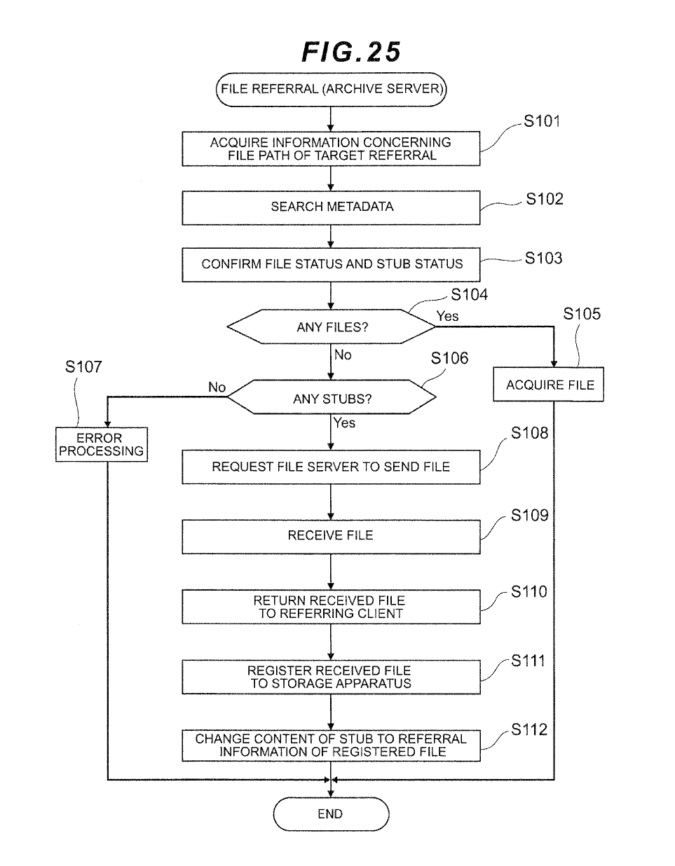

The file referral processing in the archive server 16 is now explained with reference to the flowchart of FIG. 25. Foremost, when the CPU 136 of the archive server 16 receives the file referral request 32 from the referring client 22, it acquires information concerning the file path of the referral target file 26 based on the search condition designated in the file referral request 32 (S101), searches for the metadata 28e in the second storage apparatus 18 based on the acquired information (S102), and refers to the metadata management table 280 shown in FIG. 14A.

Here, the CPU 136 refers to the metadata management table 280 and confirms the status of existence of the referral target file 26 and the status of existence of the stub 30e (S103), determines whether there is a referral target file 26 (S104), acquired the referral target file 26 among the files 26 in the second storage apparatus 18 upon determining that there is a referral target file 26 (S105), and thereby ends the processing of this routine.

Meanwhile, if the CPU 136 determines that there is no referral target file, it determines whether there is a stub 30e (S106), and executes error processing if there is no stub 30e (S107). Meanwhile, if the CPU 136 determines that there is a stub 30e, if sends a file send request to the file server 12 based on the retained information 214 (FIG. 6B) of the stub 30e (S108).

When the referral target file 26 is subsequently sent from the file server 12 based on the processing in the file server 12, the CPU 136 receives the referral target file 26 (S109), performs processing for returning (providing) the received referral target file 26 to the referring client 22 (S110), registers the received referral target file 26 in the second storage apparatus 18 (S111), changes the contents of the stub 30e in the second storage apparatus 18 to referral information for referring to the registered file 26e (S112), and thereby ends the processing of this routine.

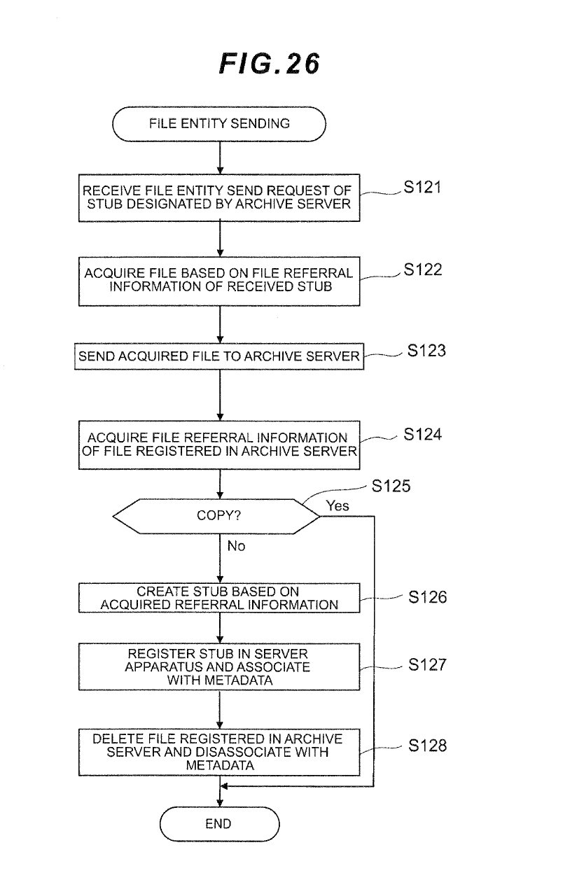

The file entity send processing in the file server 12 is now explained with reference to the flowchart of FIG. 26.

The CPU 74 of the file server 12 receives, from the archive server 16, the file entity send request of the stub 30e (file entity send request added to the designated stub 30) together with the stub 30e (S121), acquires the file 26c from the first storage apparatus 14 based on the file referral information 214F (FIG. 6B) of the received stub 30e (S122), and sends the acquired file 26c as the referral target file 26 or the migration target file 26 to the archive server 16 (S123).

The CPU 74 thereafter acquires, from the archive server 16, referral information that was created pursuant to the registration of the file 26e in the archive server 16 (referral information showing that the migration target file 26 was stored in the second storage apparatus 18 and which is referral information for accessing the migration target file 26) (S124), and determines whether it is time to perform copy processing (S125).

If it is time to perform copy processing, the CPU 74 ends the processing of this routine without executing the stub creation processing 108 or the file creation processing 94. Meanwhile, if it is not time to perform copy processing; that is, if it is time to perform post-migration processing, the CPU 74 creates a stub 30c based on referral information that was acquired from the archive server 16 (referral information showing that the migration target file 26 was stored in the second storage apparatus 18 and which is referral information for accessing the migration target file 26) (S126), registers the created stub 30c in the first storage apparatus 14, and associates the registered stub 30c and the metadata 28c (S127).

The CPU 74 thereafter deletes the file 26c that became the migration target file, disassociates the deleted file 26c and the metadata 28c (S128), and thereby ends the processing of this routine.

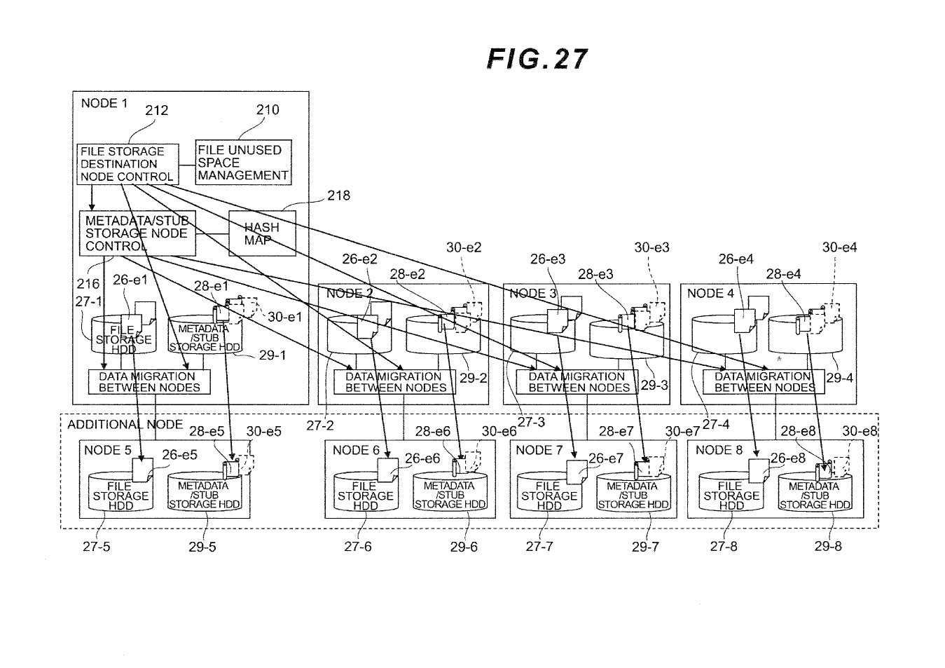

The operation of adding a node to the archive server 16 is now explained with reference to FIG. 27 to FIG. 29.

Upon adding nodes 5 to 8 to the archive server 16 in addition to the nodes 1 to 4, the CPU 136 of the node 1 confirms the unused space of the files of the respective nodes 1 to 4 as the file unused space management 210 as shown in FIG. 27, and executes the file storage destination node control processing 212.

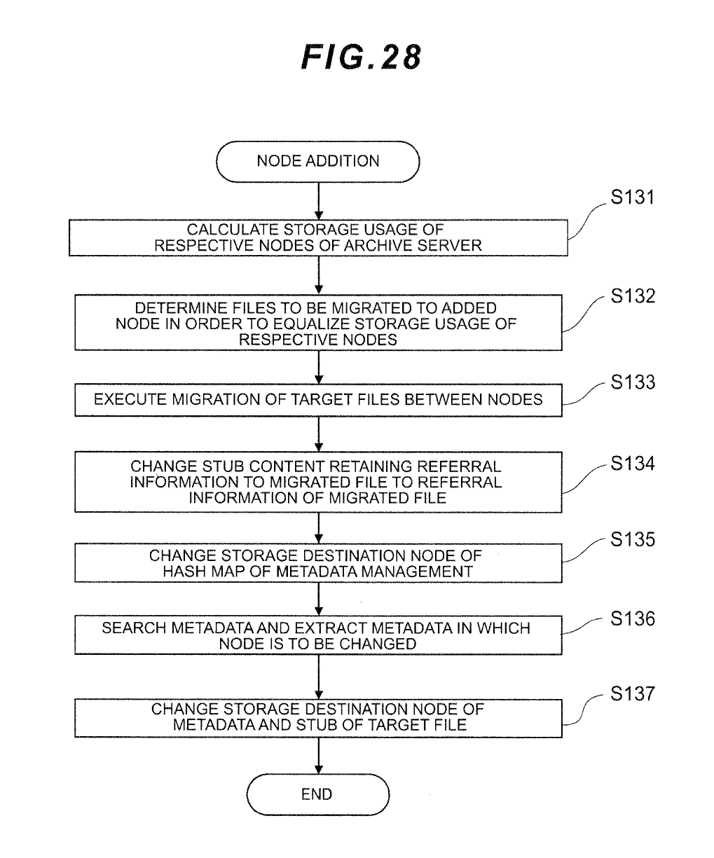

Here, the CPU 136 of the node 1 calculates the storage usage in the respective nodes 1 to 4 as shown in FIG. 28 (S131), decides the files to be migrated to the added nodes 5 to 8 so as to equalize the storage usage of the respective nodes 1 to 4 (S132), and transfers the result to the other nodes 2 to 4. The CPU 136 of the respective nodes thereafter executes the migration of the migration target files 26-e1 to 26-e4 between the nodes as shown in FIG. 27 (S133).

For example, the node 1 migrates the file 26-e1 and the metadata 28-e1 of the node 1 to the node 5, and stores them in the file storage HDD 27-5 as the file 26-5 and in metadata stub storage HDD 29-5 as the metadata 28-e5, respectively. The node 2 migrates the file 26-e2 and the metadata 28-e2 of the node 2 to the node 6, and stores them in the file storage HDD 27-6 as the file 26-e6 and in the metadata stub storage HDD 29-5 as the metadata 28-e6, respectively. The node 3 migrates the file 26-e3 and the metadata 28-e3 of the node 3 to the node 7, and stores them in the file storage HDD 27-7 as the file 26-e7 and in the metadata stub storage HDD 29-7 as the metadata 28-e7, respectively. The node 4 migrates the file 26-e4 and the metadata 28-e4 of the node 4 to the node 8, and stores them in the file storage HDD 27-8 as the file 26-e8 and in the metadata stub storage HDD 29-8 as the metadata 28-e8.

Subsequently, the CPU 136 of the node 1 performs processing for changing the contents of the stubs 30-e1 to 30-e4 retaining the referral information to the migrated files 26-e1 to 30-e4 into referral information to the migrated files 26-e5 to 26-e8 (S134).

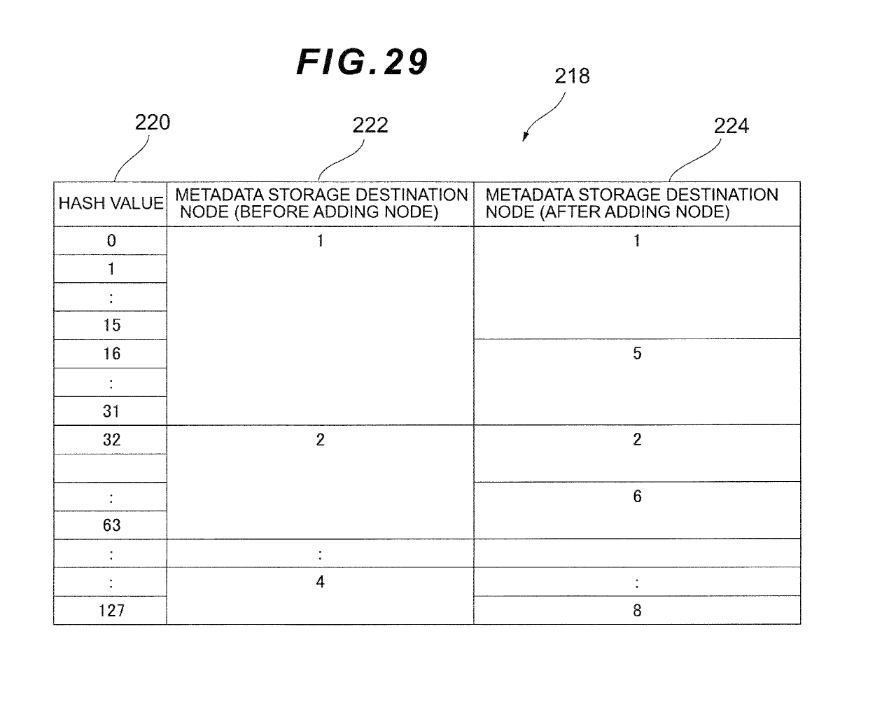

Subsequently, upon executing the metadata/stub storage node control processing 216, the CPU 137 of the node 1 adds the result of halving, for each node, the hash value 0 to 127 of the nodes 1 to 4 before the addition of the nodes as the metadata storage destination node (after addition of node) field 224 to the hash map 218 as shown in FIG. 29, and, in correspondence with each of the halved hash values, assigns the node 1 to the hash value 0 to 15, assigns the node 5 to the hash value 16 to 31, assign the node 2 to the hash value 32 to 47, assigns the node 6 to the hash value 48 to 63, assigns the node 3 to the hash value 64 to 79, assigns the node 7 to the hash value 80 to 95, assigns the node 4 to the hash value 96 to 111, and assigns the node 8 to the hash value 112 to 127 (S135).

Subsequently, the CPU 136 of the node 1 searches for the metadata 28-e1 to metadata 28-e8 of the respective nodes 1 to 8, extracts the metadata 28-e1 to metadata 28-e4 in which the node will be changed based on the search result (S136), changes the storage destination node of the metadata 28-e1 to metadata 28-e4 and the stub 30-e1 to stub 30-e4 of the file 26-e1 to file 26-e4 based on the extracted metadata 28-e1 to metadata 28-e4 (S137), and thereby ends the processing of this routine.

Consequently, even if the nodes 5 to 8 are added, the association of the file 26-e1 to file 26-e8 and metadata 28-e1 to metadata 28-e8 with the stub 30-e1 to stub 30-e8 in the respective nodes 1 to 8 is enabled.

According to this Example, even if a file referral request is input from the file referral requestor to the migration destination prior to migrating the file 26 of the migration source to the migration destination, it is possible to provide the referral target file of the file referral request to the file referral requestor.

In addition, according to the this Example, upon periodically migrating the file 26c from the file server 12 to the archive server 16, since the archive server 16 creates a stub 30c based on the metadata 28c added to the registered file 26c at the timing that the file server 12 registers the file 26c, and responds to the file referral request 22 from the referring client 22 based on the created stub 30c, the time lag in providing the referral target file 26 to the referring client 22 can be reduced.

Moreover, according to this Example, when registering the file 26c in the first storage apparatus 14, since only the metadata 28c of a smaller capacity than the file entity of the file 26c is sent from the file server 12 to the archive server 16 prior to the migration, it is possible to inhibit the increase in the load of the network (LAN switch 42) connecting the file server 12 and the archive server 16 for the archive server 16 to create the stub 30e based on the metadata 28e.

In this Example, it is also possible to leave the stub 30c corresponding to the file 26c of the migration source as is without making any change during the execution of migration.

Moreover, although this Example explained a case of executing migration with the file server 12 as the migration source and the archive server 16 as the migration destination when sending the file 26c stored in the first storage apparatus 14 from the file server 12 to the archive server 16, when sending the file 26e stored in the second storage apparatus 18 from the archive server 16 to the file server 12, the archive server 16 becomes the migration source and the file server 12 becomes the migration destination.

### Example 2

In this Example, whether the registration target file is the migration target file is determined prior to creating the stub.

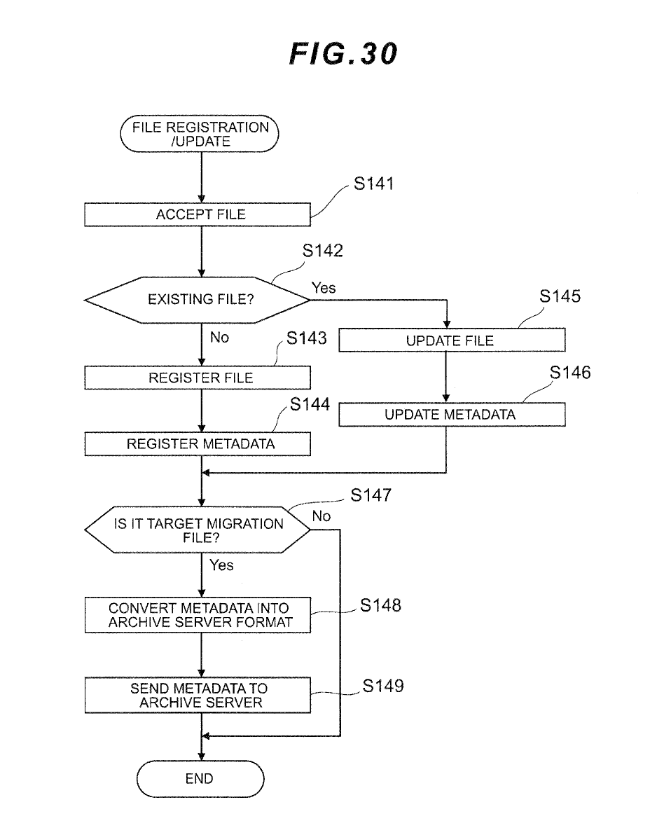

The file registration processing in Example 2 of this invention is now explained with reference to the flowchart of FIG. 30.

Foremost, when the CPU 74 in the file server 12 receives the file registration/update request 24 from the registered client 20, it accepts the file 26a that was input pursuant to the file registration/update request 24 (S141). The CPU 74 thereafter determines whether the received file 26a is an existing file (S142), registers the file 26c in the first storage apparatus 14 if it is not an existing file (S143), and registers the metadata 28c added to the file 26c in the first storage apparatus 14 (S144).

Meanwhile, at step S142, if the CPU 74 determines that the input file 26a is an existing file, the CPU 74 performs processing for updating the file 26c that is registered in the first storage apparatus 14 (S145), additionally performs processing for updating the metadata 28c that is related to the update target file 26c (S146), and then proceeds to the processing of step S147.

At step S147, the CPU 74 determines whether the registered file 26c or the updated file 26c is a migration target file. Here, the CPU 74 performs processing for determining the size of the file 26c, processing for determining the extension of the file 26c, determination processing designated by the user, or determination processing of the access authority in order to determine whether the registered file 26c or the updated file 26c is a migration target file.

If the CPU 74 determines that it is not a migration target file at step S147, the CPU 74 ends the processing of this routine. Meanwhile, if the CPU 74 determines that it is a migration target file, the CPU 74 converts the metadata 28c corresponding to the migration target file 26 into a format adopted by the archive server 16 (S148), sends the converted metadata 28c to the archive server 16 (S149), and thereby ends the processing of this routine.

According to this Example, it is possible to determine whether the registered file 26c or the updated file 26c is a migration target file prior to creating the stub.

### Example 3

In this Example, as a result of retaining the referral information to the node, the file server is able to directly access the node, and the concentration of the load on a specific node can thereby be avoided.

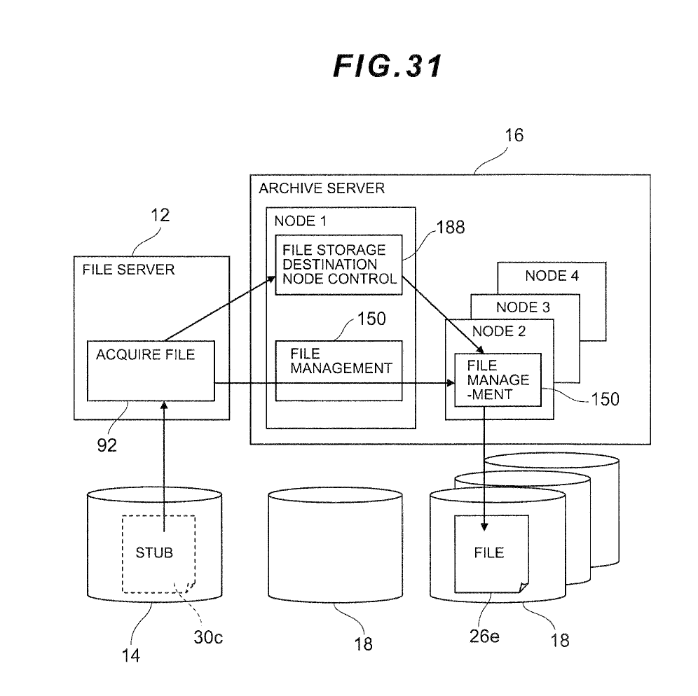

Example 3 of this invention is now explained with reference to FIG. 31.

In FIG. 31, the CPU 74 of the file server 12 refers to the stub 30c stored in the first storage apparatus 14 and executes the file acquisition processing 92.

Here, in Example 1, the CPU 74 of the file server 12 used the name space and accessed the archive server 16 without being conscious of the node, and the CPU 136 of the node 1 executed the file storage node control processing 188 according to the file management program 150 in order to access the node 2.

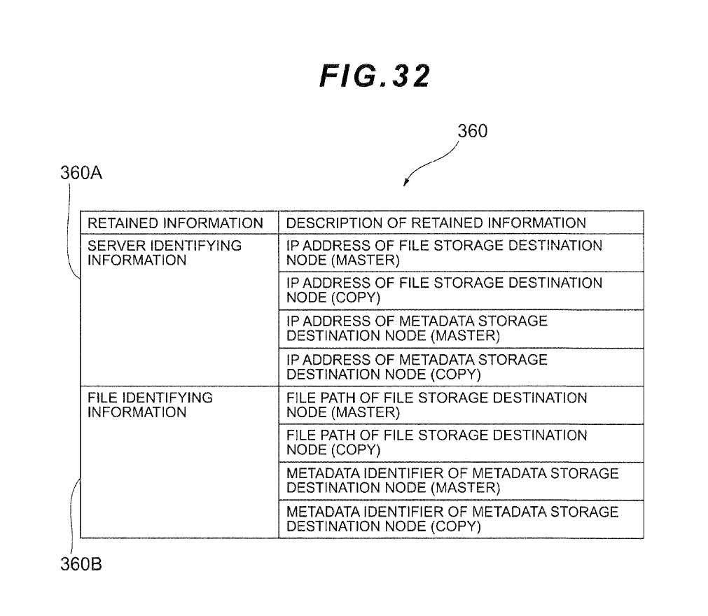

Meanwhile, in this Example, the CPU 74 of the file server 12 uses the retained information 360 of the stub 30c as shown in FIG. 32, and is able to directly access the node 2 without having to use the node management program 150 of the node 1. When the CPU 74 of the file server 12 access the node 2, the CPU 136 of the node 2 uses the file management program 150 to access the file 26.

FIG. 32 shows the configuration of the retained information 360 of the stub 30 stored in the first storage apparatus 14.

The retained information 360 of the stub 30 comprises server identifying information 360A and file identifying information 360B. The server identifying information 360A is configured from an IP address of the file storage destination node (master), an IP address of the file storage destination node (copy), an IP address of the metadata storage destination node (master), and an IP address of the metadata storage destination node (copy), and these IP addresses correspond to the nodes 1 to 4.

For example, when registering the file 26e in the node 1, registering the copy of the file 26e in the node 2, registering the metadata 28e in the node 3, and registering the copy of the metadata 28e in the node 4, the IP address of the file storage destination node (master) corresponds to the IP address of the node 1, the IP address of the file storage destination node (copy) corresponds to the IP address of the node 2, the IP address of the metadata storage destination node (master) corresponds to the IP address of the node 3, and the IP address of the metadata storage destination node (copy) corresponds to the IP address of the node 4.

The file identifying information 360B is configured from a file path in the file storage destination node (master), a file path in the file storage destination node (copy), a metadata identifier in the metadata storage destination node (master), and a metadata identifier in the metadata storage destination node (copy), and the foregoing identifying information corresponds to nodes 1 to 4.

For example, when registering the file 26e in the node 1, registering the copy of the file 26e in the node 2, registering the metadata 28e in the node 3, and registering the copy of the metadata 28e in the node 4, the file path in the file storage destination node (master) corresponds to the file path of the node 1, the file path in the file storage destination node (copy) corresponds to the file path of the node 2, the metadata identifier in the metadata storage destination node (master) corresponds to the metadata identifier of the node 3, and the metadata identifier in the metadata storage destination node (copy) corresponds to the metadata identifier of the node 4.

In this Example, as a result of indicating the file storage destination node of the archive server 16 and all storage destination nodes of the metadata 28e and the stub 30e in the stub 30c, the file server 12 is able to directly access the respective nodes 1 to 4.

According to this Example, as a result of using the retained information 360 of the stub 30c, the file server 12 is able to directly access the respective nodes 1 to 4 without having to use the node management program 150 of the node 1, and it is thereby possible to reduce the load of the node 1 as the master node.

### REFERENCE SIGNS LIST

10 Storage system
12 File server
14 First storage apparatus
16 Archive server
18 Second storage apparatus
20 Registered client
22 Referring client
26 File
28 Metadata
30 Stub
70 Program memory
74 CPU
76 HDD
132 Program memory
136 CPU
138 HDD
80 File management program
82 Data send/receive program
84 Stub management program
86 Metadata management program
88 Migration program
142 File management program
144 Data send/receive program
146 Stub management program
148 Metadata management program
150 Node management program

1. A storage system, comprising:
a first memory device for storing data concerning a plurality of files;
a first server for controlling the input and output of data to and from the first memory device;
a second memory device to become a migration destination of data stored in the first memory device; and
a second server for sending and receiving data to and from the first server via a network, and controlling the input and output of data to and from the second memory device,
wherein, when the first server receives a file registration request from a file registration requestor client, the first server stores a file that was input pursuant to the file registration request and metadata added to the file in the first memory device, sends the metadata to the second server,
wherein, when the second server receives the metadata that was sent from the first server, the second server creates a stub as referral information for accessing a file corresponding to the received metadata based on the received metadata, stores the created stub and the received metadata in the second memory device, and, upon subsequently receiving a file referral request from a file referral requestor client, searches for the stub and the metadata stored in the second memory device according to the file referral request, determines a storage destination of a referral target file as a target of the file referral request based on the search result, and provides the referral target file existing in the determined storage destination to the file referral requestor client.

2. The storage system according to claim 1,
wherein the second server is an archive server which, upon receiving the file referral request, searches for the stub and the metadata stored in the second memory device according to the file referral request,
determines whether a referral target file as a target of the file referral request exists in the second memory device based on the search result of the metadata,
acquires the referral target file from the second memory device upon determining that the referral target file exists in the second memory device,
provides the acquired referral target file to the file referral requestor client,
determines whether the referral target file exists in the first memory device based on the search result of the stub upon determining that the referral target file does not exist in the second memory device, and
requests the first server as a file server to send the referral target file upon determining that the referral target file exists in the first memory device,
wherein the first server acquires the referral target file, which was designated in the send request from the second server, from the first memory device, and sends the acquired referral target file as a migration target file to the second server, and
wherein, when the second server receives the migration target file from the first server, the second server provides the received migration target file as the referral target file to the file referral requestor client, and stores the received migration target file in the second memory device.

3. The storage system according to claim 1,
wherein, when the second server determines that the storage destination of the referral target file is the first memory device, the second server requests the first server to process the referral target file among the files existing in the first memory device as a migration target file to become a migration target,
wherein, in response to a request from the second server, the first server sends the referral target file among the files existing in the first memory device as a migration target file to the second server, and
wherein, when the second server subsequently receives the migration target file from the first server, the second server provides the received migration target file as the referral target file to the file referral requestor client.

4. The storage system according to claim 1,
wherein, when the second server determines that the storage destination of the referral target file is the first memory device, the second server requests the first server to process the referral target file among the files existing in the first memory device as a migration target file to become a migration target,
wherein, in response to the request from the second server, the first server acquires the referral target file from the first memory device, and sends the acquired referral target file as the migration target file to the second server, and
wherein, when the second server receives the migration target file from the first server, the second server provides the received migration target file as the referral target file to the file referral requestor client, and
stores the received migration target file in the second memory device.

5. The storage system according to claim 4,
wherein, when the second server stores the received migration target file in the second memory device, the second server changes contents of a stub corresponding to the received migration target file to referral information showing access to the migration target file stored in the second memory device.

6. The storage system according to claim 1,
wherein, when the file input together with the file registration request becomes a migration target, the first server sends a migration target file that became the migration target to the second server, and
wherein, when the first server sends the migration target file to the second server as the migration destination, the first server creates a stub as referral information for accessing the migration target file of the migration destination based on metadata corresponding to the migration target file that was sent to the migration destination, and stores the created stub in the second memory device upon associating the created stub with metadata corresponding to the migration target file that was sent to the migration destination.

7. The storage system according to claim 6,
wherein, when the first server receives a file referral request from the file referral requestor client, the first server searches the stub and the metadata stored in the first memory device according to the file referral request, determines a storage destination of a referral target file as a target of the file referral request based on the search result, and
provides the referral target file existing in the determined storage destination to the file referral requestor client.

8. The storage system according to claim 7,
wherein, when the first server determines that the storage destination of the referral target file is the second memory device, the first server requests the second server to process the referral target file among the files existing in the second memory device as the migration target file,
wherein, in response to the request from the first server, the second server acquires the referral target file from the second memory device, and sends the acquired referral target file as the migration target file to the first server, and
wherein, when the first server receives the migration target file from the second server, the first server provides the received migration target file as the referral target file to the file referral requestor client, and stores the received migration target file in the first memory device.

9. A file management method of a storage system comprising a first memory device for storing data concerning a plurality of files, a first server for controlling the input and output of data to and from the first memory device, a second memory device to become a migration destination of data stored in the first memory device, and a second server for sending and receiving data to and from the first server via a network, and controlling the input and output of data to and from the second memory device,
wherein the first server comprises:
a step of storing a file that was input pursuant to the file registration request and metadata added to the file in the first memory device and sending the metadata to the second server upon receiving a file registration request from a file registration requestor client,
wherein the second server comprises:
a step of creating a stub as referral information for accessing a file corresponding to the received metadata based on the received metadata upon receiving the metadata that was sent from the first server;
a step of storing the stub that was created at the creation step and the received metadata in the second memory device;
a step of searching for the stub and the metadata stored in the second memory device according to the file referral request upon subsequently receiving a file referral request from a file referral requestor client;
a step of determining a storage destination of a referral target file as a target of the file referral request based on the search result of the search step; and
a step of providing the referral target file existing in the storage destination that was determined at the determination step to the file referral requestor client.

10. The file management method of a storage system according to claim 9,
wherein the second server comprises:
a step of requesting the first server to process the referral target file among the files existing in the first memory device as a migration target file to become a migration target upon determining that the storage destination of the referral target file is the first memory device,
wherein the first server comprises:
a step of sending, in response to a request from the second server, the referral target file among the files existing in the first memory device as a migration target file to the second server, and
wherein the second server further comprises:
a step of providing the received migration target file as the referral target file to the file referral requestor client upon subsequently receiving the migration target file from the first server.

11. The file management method of a storage system according to claim 9,
wherein the second server comprises:
a step of requesting the first server to process the referral target file among the files existing in the first memory device as a migration target file to become the migration target upon determining that the storage destination of the referral target file is the first memory device,
wherein the first server comprises:
a step of acquiring the referral target file from the first memory device in response to the request from the second server; and
a step of sending the referral target file that was acquired at the acquisition step as the migration target file to the second server, and
wherein the second server further comprises:
a step of providing the received migration target file as the referral target file to the file referral requestor client upon receiving the migration target file from the first server; and
a step of storing the received migration target file in the second memory device.

12. The file management method of a storage system according to claim 11,
wherein the second server comprises:
a step of changing contents of a stub corresponding to the received migration target file to referral information showing access to the migration target file stored in the second memory device upon storing the received migration target file in the second memory device.

13. The file management method of a storage system according to claim 9,
wherein the first server comprises:
a step of sending, when the file input together with the file registration request becomes a migration target, a migration target file that became the migration target to the second server,
a step of creating a stub as referral information for accessing the migration target file of the migration destination based on metadata corresponding to the migration target file that was sent to the migration destination upon sending the migration target file to the second server as the migration destination; and
a step of storing the stub that was created at the creation step in the second memory device upon associating the created stub with metadata corresponding to the migration target file that was sent to the migration destination.

14. The file management method of a storage system according to claim 13,
wherein the first server comprises:
a step of searching the stub and the metadata stored in the first memory device according to the file referral request, determines a storage destination of a referral target file as a target of the file referral request based on the search result upon receiving a file referral request from the file referral requestor client; and
a step of determining a storage destination of a referral target file as a target of the file referral request based on the search result of the search step; and
a step of providing the referral target file existing in the storage destination that was determined at the determination step to the file referral requestor client.

15. The file management method of a storage system according to claim 14,
wherein the first server comprises:
a step of requesting the second server to process the referral target file among the files existing in the second memory device as the migration target file upon determining that the storage destination of the referral target file is the second memory device,
wherein the second server comprises:
a step of acquiring the referral target file from the second memory device in response to the request from the first server; and
a step of sending the referral target file that was acquired at the acquisition step as the migration target file to the first server, and
wherein the first server further comprises:
a step of providing the received migration target file as the referral target file to the file referral requestor client upon receiving the migration target file from the second server; and
a step of storing the received migration target file in the first memory device.
